(19) United States
(12) Patent Application Publication
(10) Pub. No.: US 2026/0134825 A1
(43) Pub. Date: May 14, 2026

(54) PIXEL CIRCUIT, DRIVING METHOD THEREOF AND DISPLAY APPARATUS

(71) Applicant: HISENSE VISUAL TECHNOLOGY CO., LTD., Qingdao (CN)

(72) Inventors: Yudong RONG, Qingdao (CN); Wenyuan XI, Qingdao (CN); Liangyu ZHANG, Qingdao (CN); Jiancheng SHAO, Qingdao (CN); Xueli LIU, Qingdao (CN); Minhua LI, Qingdao (CN); Fei HUANG, Qingdao (CN)

(21) Appl. No.: 19/442,742

(22) Filed: Jan. 7, 2026

Related U.S. Application Data
(63) Continuation of application No. PCT/CN2024/098494, filed on Jun. 11, 2024.

(30) Foreign Application Priority Data
Jul. 18, 2023 (CN) 202310882614.6
Sep. 18, 2023 (CN) 202311206387.1
Sep. 22, 2023 (CN) 202311230211.X

(51) Int. Cl. G09G 3/32; G09G 3/20; G09G 3/3233

(52) U.S. Cl. CPC G09G 3/32; G09G 3/2011; G09G 3/2018; G09G 3/2081; G09G 3/3233; G09G 2300/0465; G09G 2300/0819; G09G 2300/0842; G09G 2300/0847; G09G 2300/0852; G09G 2300/0861; G09G 2310/066; G09G 2310/08; G09G 2320/0233; G09G 2320/045; G09G 2330/021

(57) ABSTRACT

Disclosed are a pixel circuit and a display apparatus. The pixel circuit includes a first transistor, a second transistor, a third transistor and a light-emitting element, where a first electrode of the first transistor and a first electrode of the second transistor are configured to receive a power signal, a second electrode of the first transistor is connected to the light-emitting element, and a gate electrode of the first transistor is connected to a second electrode of the second transistor, a gate electrode of the second transistor and a second electrode of the third transistor; a first electrode of the third transistor is configured to receive a reset signal, and a gate electrode of the third transistor is configured to receive a reset control signal.

### CROSS-REFERENCE OF RELATED APPLICATIONS

The present application is a continuation application of PCT Application No. PCT/CN2024/098494, filed on Jun. 11, 2024, which claims the priorities to Chinese Patent Application No. 202310882614.6, filed on Jul. 18, 2023, No. 202311206387.1, filed on Sep. 18, 2023, and No. 202311230211.X, filed on Sep. 22, 2023, all of which are incorporated herein by reference in their entirety.

### FIELD OF INVENTION

The present application relates to display apparatus, and particularly relates to a pixel circuit, a method for driving the pixel circuit and a display apparatus.

### BACKGROUND

In related technologies, the display panel has multiple pixel circuits and micro-LEDs corresponding to the pixel circuits. Micro Light Emitting Diode (micro-LED, also known as μLED) has advantages over Active matrix organic light emitting diode (AMOLED) such as smaller size, faster response speed, higher luminous efficiency, stronger stability, and longer lifespan.

Because the IV characteristic curve of micro-LED is very steep, that is, the voltage change between the two poles corresponding to the transition from low grayscale current to high grayscale current is extremely small, traditional driving methods, such as Pulse Amplitude Modulation (PAM) driving, require extremely fast clock signals to meet extremely high voltage resolution, such as Complementary Metal Oxide Semiconductor (CMOS) driving. However, CMOS driving has adverse effects on the flexibility, transparency, and thickness of the panel. If another traditional driving method, such as Pulse Width Modulation (PWM) driving, is used, a Gate Driven on Array (GOA) can be configured to generate a driving control signal to achieve higher grayscale. However, the driving speed of the GOA circuit is limited. When the resolution is high, multiple turns-on will cause the light-emitting element to be unable to emit light for a long period of time, which will limit the improvement of grayscale.

Therefore, by combining PWM and PAM driving methods, the driving voltage of the light-emitting element can be increased by the PAM module, while the light-emitting time of the light-emitting element can be extended by the PWM module, thereby achieving a higher grayscale, without requiring excessively high circuit driving speed. However, using two driving methods inevitably results in a larger number of components being used in the pixel circuit, thus occupying more area of the display panel.

### BRIEF SUMMARY

Embodiments of the present application provide a pixel circuit, the pixel circuit can include a first transistor, a second transistor, a third transistor, and a light-emitting element, where: a first electrode of the first transistor and a first electrode of the second transistor can be configured to receive a power signal, a second electrode of the first transistor is connected to the light-emitting element, and a gate electrode of the first transistor is connected to a second electrode of the second transistor, a gate electrode of the second transistor and a second electrode of the third transistor; a first electrode of the third transistor is configured to receive a reset signal, and a gate electrode of the third transistor can be configured to receive a reset control signal; the first transistor can be configured to provide a driving signal to the light-emitting element, the second transistor can be configured to provide a light emission duration control signal to the first transistor to control a light emission duration of the light-emitting element, and the third transistor can be configured to provide the reset signal to the gate electrode of the second transistor and the gate electrode of the first transistor in response to the reset control signal received at the gate electrode of the third transistor.

Embodiments of the present application provide a method for driving the pixel circuit, the method can include: in a first reset phase, controlling the third transistor to turn on in response to the reset control signal being at an active potential; providing the reset signal to the gate electrode of the first transistor and the gate electrode of the second transistor through the third transistor; and controlling the second transistor to turn on in response to the reset signal.

Embodiments of the present application provide a display apparatus, the display apparatus can include a data driving circuit, a scan driving circuit, a plurality of data lines, a plurality of scan lines, and any of the pixel circuits described above.

### BRIEF DESCRIPTION OF THE DRAWINGS

FIG. 1 is a schematic diagram of a display apparatus according to some embodiments of the present application.

FIG. 2 is a schematic diagram of a structure of a pixel circuit according to some embodiments of the present application.

FIG. 3 is another schematic diagram of a structure of a pixel circuit according to some embodiments of the present application.

FIG. 4 is another schematic diagram of a structure of a pixel circuit according to some embodiments of the present application.

FIG. 5 is another schematic diagram of a structure of a pixel circuit according to some embodiments of the present application.

FIG. 6 is another schematic diagram of a structure of a pixel circuit according to some embodiments of the present application.

FIG. 7 is another schematic diagram of a structure of a pixel circuit according to some embodiments of the present application.

FIG. 8 is another schematic diagram of a structure of a pixel circuit according to some embodiments of the present application.

FIG. 9 is another schematic diagram of a structure of a pixel circuit according to some embodiments of the present application.

FIG. 10 is another schematic diagram of a structure of a pixel circuit according to some embodiments of the present application.

FIG. 11 is a timing diagram of driving signals for a pixel circuit according to some embodiments of the present application.

FIG. 12 is a schematic diagram of the turned-on states of the transistors in a pixel circuit according to some embodiments of the present application.

FIG. 13 is another schematic diagram of the turned-on states of the transistors in a pixel circuit according to some embodiments of the present application.

FIG. 14 is another schematic diagram of the turned-on states of the transistors in a pixel circuit according to some embodiments of the present application.

FIG. 15 is another schematic diagram of the turned-on states of the transistors in a pixel circuit according to some embodiments of the present application.

FIG. 16 is another schematic diagram of the turned-on states of the transistors in a pixel circuit according to some embodiments of the present application.

FIG. 17 is another schematic diagram of the turned-on states of the transistors in a pixel circuit according to some embodiments of the present application.

FIG. 18 is another schematic diagram of the turned-on states of the transistors in a pixel circuit according to some embodiments of the present application.

FIG. 19 is another timing diagram of the driving signals of a pixel circuit according to some other embodiments of the present application.

FIG. 20 is another schematic diagram of a structure of a pixel circuit according to some embodiments of the present application.

FIG. 21 is another timing diagram of the driving signals of a pixel circuit according to some other embodiments of the present application.

FIG. 22 is another timing diagram of the driving signals of a pixel circuit according to some other embodiments of the present application.

FIG. 23 is another schematic diagram of a structure of a pixel circuit according to some embodiments of the present application.

FIG. 24 is another schematic diagram of a structure of a pixel circuit according to some embodiments of the present application.

FIG. 25 is another schematic diagram of a structure of a pixel circuit according to some embodiments of the present application.

FIG. 26 is another schematic diagram of a structure of a pixel circuit according to some embodiments of the present application.

FIG. 27 is another schematic diagram of a structure of a pixel circuit according to some embodiments of the present application.

FIG. 28 is another schematic diagram of a structure of a pixel circuit according to some embodiments of the present application.

FIG. 29 is another schematic diagram of a structure of a pixel circuit according to some embodiments of the present application.

FIG. 30 is another schematic diagram of a structure of a pixel circuit according to some embodiments of the present application.

FIG. 31 is another schematic diagram of a structure of a pixel circuit according to some embodiments of the present application.

FIG. 32 is another timing diagram of the driving signals of a pixel circuit according to some other embodiments of the present application.

FIG. 33 is another schematic diagram of the turned-on states of the transistors in a pixel circuit according to some embodiments of the present application.

FIG. 34 is another schematic diagram of the turned-on states of the transistors in a pixel circuit according to some embodiments of the present application.

FIG. 35 is another schematic diagram of the turned-on states of the transistors in a pixel circuit according to some embodiments of the present application.

FIG. 36 is another schematic diagram of the turned-on states of the transistors in a pixel circuit according to some embodiments of the present application.

FIG. 37 is another schematic diagram of the turned-on states of the transistors in a pixel circuit according to some embodiments of the present application.

FIG. 38 is another schematic diagram of the turned-on states of the transistors in a pixel circuit according to some embodiments of the present application.

FIG. 39 is another schematic diagram of the turned-on states of the transistors in a pixel circuit according to some embodiments of the present application.

FIG. 40 is another timing diagram of the driving signals of a pixel circuit according to some other embodiments of the present application.

FIG. 41 is another timing diagram of the driving signals of a pixel circuit according to some other embodiments of the present application.

FIG. 42 is another schematic diagram of a structure of a pixel circuit according to some embodiments of the present application.

FIG. 43 is another timing diagram of the driving signals of a pixel circuit according to some other embodiments of the present application.

FIG. 44 is another timing diagram of the driving signals of a pixel circuit according to some other embodiments of the present application.

FIG. 45 is another timing diagram of the driving signals of a pixel circuit according to some other embodiments of the present application.

FIG. 46 is another schematic diagram of a display apparatus according to some embodiments of the present application.

FIG. 47 is another schematic diagram of the structure of a pixel circuit according to some embodiments of the present application.

FIG. 48 is a timing diagram of control signals according to some embodiments of the present application.

FIG. 49 is a schematic diagram of the pixel circuit during the first reset phase according to some embodiments of the present application.

FIG. 50 is a schematic diagram of the pixel circuit during the first compensation phase according to some embodiments of the present application.

FIG. 51 is a schematic diagram of a pixel circuit during the first data writing phase according to some embodiments of the present application.

FIG. 52 is a schematic diagram of the pixel circuit during the second reset phase according to some embodiments of the present application.

FIG. 53 is a schematic diagram of the pixel circuit during the second compensation phase according to some embodiments of the present application.

FIG. 54 is a schematic diagram of the pixel circuit during the second data writing phase according to some embodiments of the present application.

FIG. 55 is a schematic diagram of a pixel circuit during the light-emitting phase according to some embodiments of the present application.

FIG. 56 is another schematic diagram of a pixel circuit during the light-emitting phase according to some embodiments of the present application.

FIG. 57 is another schematic diagram of the pixel circuit according to some embodiments of the present application.

FIG. 58 is another timing diagram of control signals according to some embodiments of the present application.

### DETAILED DESCRIPTION OF THE EMBODIMENTS

To make the objectives, implementation methods and advantages of the present application clearer, some implementation methods of the present application will be clearly and completely described below with reference to the accompanying drawings of some embodiments of the present application. Obviously, the described embodiments are only some embodiments of the present application, and not all embodiments.

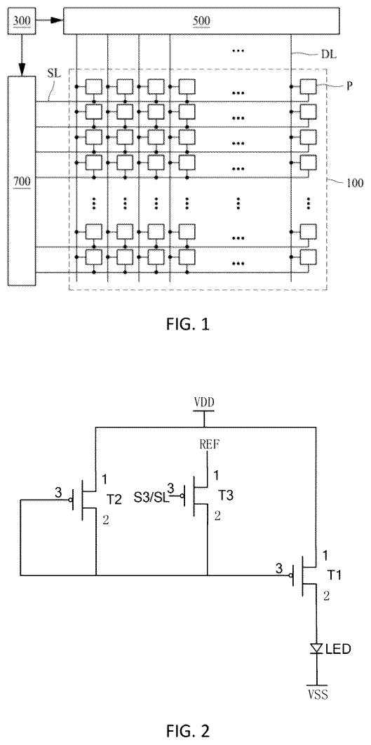

FIG. 1 is a schematic diagram of a display apparatus according to some embodiments of the present application. Referring to FIG. 1, the display apparatus can include a pixel array unit 100, a control circuit 300, a data driving circuit 500 (e.g., a data driver) and a scan driving circuit 700 (e.g., a gate driver). The pixel array unit 100 can include the plurality of scan lines SL and the plurality of data lines DL arranged on a base substrate, and the plurality of pixels P arranged in the plurality of pixel regions defined by the intersection of the plurality of scan lines SL and the plurality of data lines DL.

Each of the plurality of pixels P can include a pixel circuit in embodiments of the present application for displaying an image based on a scan signal provided by an adjacent scan line SL and a data signal provided by an adjacent data line DL. In detail, the pixel circuit can include at least one thin-film transistor and at least one capacitor. The pixel circuit can be a liquid crystal unit that displays an image by driving the liquid crystal according to an electric field based on a data signal, or it can be a self-emissive unit that displays an image by emitting light based on a data signal. In this case, the self-emissive unit can include a plasma discharge element, a quantum dot light-emitting element, an organic light-emitting element, or an inorganic light-emitting element, where the inorganic light-emitting element can be a micro light-emitting diode. The signals received by the pixel circuits in the following embodiments of the present application are all provided by the control circuit 300, the data driving circuit 500 and the scan driving circuit 700 described above.

The control circuit 300 can generate pixel data corresponding to each of the plurality of pixels P based on the image signal. The control circuit 300 can generate a data control signal based on the timing synchronization signal, and provide the data control signal to the data driving circuit 500. In some embodiments, the control circuit 300 can generate a scan control signal, which can include a start signal and the plurality of scan clock signals, based on a timing synchronization signal, to provide the scan control signal to the scan driving circuit 700. The control circuit 300 can generate the plurality of carry clock signals according to the driving mode of the scan driving circuit 700, so as to provide the plurality of carry clock signals to the scan driving circuit 700. The data driving circuit 500 can be connected to the plurality of data lines DL disposed in the pixel array unit 100. The data driving circuit 500 can receive pixel data and data control signals provided by the control circuit 300, and can also receive the plurality of reference gamma voltages provided by the power supply circuit. The data driving circuit 500 can convert pixel data into pixel-based analog data signals using data control signals and the plurality of reference gamma voltages, and can provide the pixel-based analog data signals to the corresponding data lines DL.

The scan driving circuit 700 can be connected to the plurality of scan lines SL disposed in the pixel array unit 100. In detail, the scan driving circuit 700 can generate scan signals according to a predetermined sequence determined based on the scan control signal provided by the control circuit 300 and can provide the scan signals to the corresponding scan lines SL.

In some embodiments, the scan driving circuit 700 can be integrated on one or both edges of the base substrate according to the thin-film transistor manufacturing process, and then connected to the plurality of scan lines SL in a corresponding relationship. For example, the scan driving circuit 700 can be disposed in an integrated circuit, can be encapsulated in a base substrate or flexible circuit film, and can be connected to the plurality of scan lines SL in a one-to-one correspondence.

In related technologies, in order to combine the driving methods of PWM and PAM, corresponding thin-film transistors and/or capacitors need to be added to the pixel circuit. For example, both the PWM module and the PAM module need to be equipped with thin-film transistors for driving. In order to achieve better display effects, other circuit designs are required for the thin-film transistors used for driving. This inevitably results in the pixel circuit having a larger number of devices, causing the pixel array unit 100 to occupy a larger area of the display panel with the same number of light-emitting units, thus affecting the overall display effect of the display apparatus. Furthermore, the number of scan lines SL and data lines DL, as well as the number of components in the control circuit 300, data driving circuit 500, and scan driving circuit 700, also need to be increased accordingly, resulting in an increase in the bezel region and overall weight and volume of the display apparatus.

In view of this, embodiments of the present application provide a pixel circuit, as shown in FIG. 2. In FIG. 2, reference numeral 1 is the first electrode, 2 is the second electrode, and 3 is the gate electrode. As those skilled in the art will understand, since the signal potentials in the pixel circuit are different in different implementation scenarios, for the same transistor, the first electrode can be the source electrode and the second electrode can be the drain electrode in one implementation scenario, and the first electrode can be the drain electrode and the second electrode can be the source electrode in another implementation scenario. The first electrode and the second electrode in the embodiments of the present application are only configured to distinguish the two pins of the transistor other than the gate electrode, and are not limited in any other way. The accompanying drawings of other embodiments of the present application and other embodiments are similar and will not be described again.

The pixel circuit described above can include a first transistor T1, a second transistor T2, a third transistor T3, and a light-emitting element. It should be noted that in figures and embodiments of the present application, the light emitting element is described as Light Emitting Diode, LED. However, the light emitting element of the present application can be any type of light emitting element, which is not limited here.

The first electrode of the first transistor T1 and the first electrode of the second transistor T2 can be configured to receive the power supply signal VDD, and the second electrode of the first transistor T1 is connected to the light-emitting element LED. The first transistor T1 can be configured to provide a driving signal for the light-emitting element LED.

The second electrode of the second transistor T2 is connected to the gate electrode of the first transistor T1. The second transistor T2 can be configured to provide a control signal to the first transistor T1 to control the duration of light emission of the light-emitting element.

In some embodiments, the first transistor T1 can provide driving signals of different amplitudes to the light-emitting element LED, realizing the PAM driving mode, which can provide a higher driving voltage to the light-emitting element LED, thereby improving the grayscale of the circuit. The second transistor T2 can control the turn-on and turn-off of the first transistor T1 by applying a light emission duration control signal to the gate electrode of the first transistor T1, thereby controlling the time when the first transistor T1 provides a driving signal to the light-emitting element LED. This increases the proportion of the light emission time of the light-emitting device to the refresh frame, extends the light emission time of the light-emitting element LED, and thus realizes the PWM driving method, thereby improving the brightness perceived by the human eye and improving the grayscale of the circuit.

The second electrode of the third transistor T3 is connected to the gate electrode of the first transistor T1 and the gate electrode of the second transistor T2. The first electrode of the third transistor T3 can be configured to receive the reset signal REF, and the gate electrode of the third transistor T3 can be configured to receive the reset control signal S3. The third transistor T3 can be configured to provide a reset signal REF to the second transistor T2 and the first transistor T1 in response to the reset control signal S3 received at the gate electrode of the third transistor T3. In some embodiments, when the reset control signal S3 is active, the third transistor T3 is turned on, and the reset signal REF can be provided to the second electrode of the third transistor T3 through the first electrode of the third transistor T3.

In some embodiments, as shown in FIGS. 1 and 2, the reset control signal S3 is provided by the scan line SL. The reset signal REF can be provided by the data line DL or connected to a fixed potential.

The first transistor T1 and the second transistor T2 are driving transistors. Their gate potentials change after each time the light-emitting element LED is controlled to emit light. Therefore, in order to ensure that the state of the driving transistors is the same at the beginning of each light-emitting process, the first transistor T1 and the second transistor T2 need to be reset before controlling the light-emitting element LED to emit light. In related technologies, since the two transistors are located in different positions in the pixel circuit, two reset transistors are usually set for the two driving transistors, which increases the number of transistors in the pixel circuit to a certain extent. However, in embodiments of the present application, one third transistor T3 can reset the first transistor T1 and the second transistor T2, reducing one transistor for each pixel circuit. For the entire display apparatus, this means reducing N transistors in N pixel circuits, directly reducing the number of components in the display apparatus, thereby saving the area occupied by the pixel circuit in the display panel and effectively improving the pixel density and display panel resolution.

In some embodiments, the light-emitting element LED can be a micro LED or other light-emitting element that can be applied to pixel circuits, without excessive limitation here.

In some embodiments, the specific model and parameters of the transistors in embodiments of the present application can be set by those skilled in the art according to the actual situation. The transistors can be P-type transistors or N-type transistors, thin film transistors (TFTs), metal-oxygen-semiconductor field-effect transistors (MOSFETs), or low-temperature poly-silicon (LTPS) thin film transistors. No further limitations are made here. The same applies to other transistors in embodiments of the present application, which will not be described in detail here.

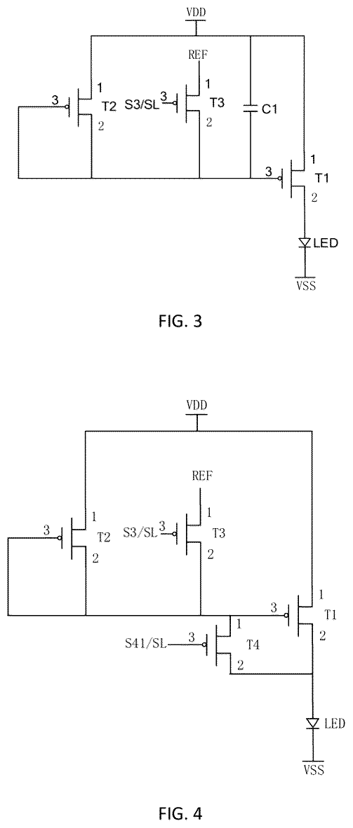

In some embodiments, as shown in FIG. 3, the pixel circuit can further include a first capacitor C1, the first electrode of the first capacitor C1 is connected to the gate electrode of the first transistor T1, and the second electrode of the first capacitor C1 can be configured to receive the power supply signal VDD. In some embodiments, the third transistor T3 can reset the potential of the gate electrode of the first transistor T1 to the reset voltage by charging the first capacitor C1 connected to the gate electrode of the first transistor T1. In this embodiment, the working principle of the third transistor T3 is the same as in the above embodiments, and will not be repeated here. In some embodiments, the specific model and capacitance value of the first capacitor C1 can be set by those skilled in the art according to the actual situation, and are not limited here. The same applies to other capacitors in embodiments of the present application, and will not be described in detail here.

In some embodiments, as shown in FIG. 4, the pixel circuit can further include a fourth transistor T4, the first electrode of the fourth transistor T4 is connected to the gate electrode of the first transistor T1, the second electrode of the fourth transistor T4 is connected to the second electrode of the first transistor T1, and the gate electrode of the fourth transistor T4 can be configured to receive a first compensation control signal S41. In some embodiments, as shown in FIGS. 1 and 4, the first compensation control signal S41 is provided by the scan line SL.

The fourth transistor T4 can be configured to provide threshold compensation for the first transistor T1 in response to the first compensation control signal S41 received at the gate electrode of the fourth transistor T4. In some embodiments, when the first compensation control signal S41 is at an active potential, the fourth transistor T4 is turned on, compensating the potential of the second electrode of the first transistor T1 to the gate electrode of the first transistor T1, thereby completing the threshold compensation of the first transistor T1.

In some embodiments, due to the influence of the uniformity of the manufacturing process, the threshold voltage of the first transistor T1 drifts, which affects the magnitude of the driving current or driving voltage of the light-emitting element, resulting in non-uniform wavelength of light emitted by the light-emitting element, thereby affecting the display color and display effect of the panel. In the above embodiments of the present application, by adding a fourth transistor T4 between the gate electrode of the first transistor T1 and the second electrode of the first transistor T1, threshold compensation can be performed on the first transistor T1, thereby achieving a better display effect. In this embodiment, the working principle of the third transistor T3 is the same as in the above embodiments, and will not be repeated here.

In some embodiments, as shown in FIG. 5, the pixel circuit can further include a fifth transistor T5, the first electrode of the fifth transistor T5 is connected to the gate electrode of the second transistor T2, the second electrode of the fifth transistor T5 is connected to the second electrode of the second transistor T2 and the second electrode of the third transistor T3, and the gate electrode of the fifth transistor T5 can be configured to receive a first compensation and reset control signal S1. As shown in FIGS. 1 and 5, the first compensation and reset control signal S1 can be provided by the scan line SL.

The fifth transistor T5 can be configured to provide the reset signal REF provided by the third transistor T3 received at the second electrode of the fifth transistor T5 to the gate electrode of the second transistor T2 through the first electrode of the fifth transistor T5 in response to the first compensation and reset control signal S1 received through the gate electrode of the fifth transistor T5; and to provide threshold compensation for the second transistor T2 in response to the first compensation and reset control signal S1 received through the gate electrode of the fifth transistor T5.

In some embodiments, when the third transistor T3 is turned on to reset the second transistor T2, the first compensation and reset control signal S1 is at an active potential, the fifth transistor T5 is turned on, and the reset signal REF provided by the third transistor T3 is provided to the gate electrode of the second transistor T2. When threshold compensation is required for the second transistor T2, only when the first compensation control signal S41 is at an active potential will the fifth transistor T5 be turned on, compensating the potential of the second electrode of the second transistor T2 to the gate electrode of the second transistor T2, thereby completing the threshold compensation for the second transistor T2.

In some embodiments, due to the influence of the uniformity of the manufacturing process, the threshold voltage of the second transistor T2 drifts, which affects the magnitude of the driving current or driving voltage of the light-emitting element, resulting in non-uniform wavelength of light emitted by the light-emitting element, thereby affecting the display color and display effect of the panel. In the above embodiments of the present application, by adding a fifth transistor T5 between the gate electrode of the second transistor T2 and the second electrode of the second transistor T2, threshold compensation can be performed on the second transistor T2, thereby achieving a better display effect. Meanwhile, the aforementioned fifth transistor T5 can be disposed between the gate electrode of the second transistor T2 and the second electrode of the third transistor T3, and can work with the third transistor T3 to reset the second transistor T2.

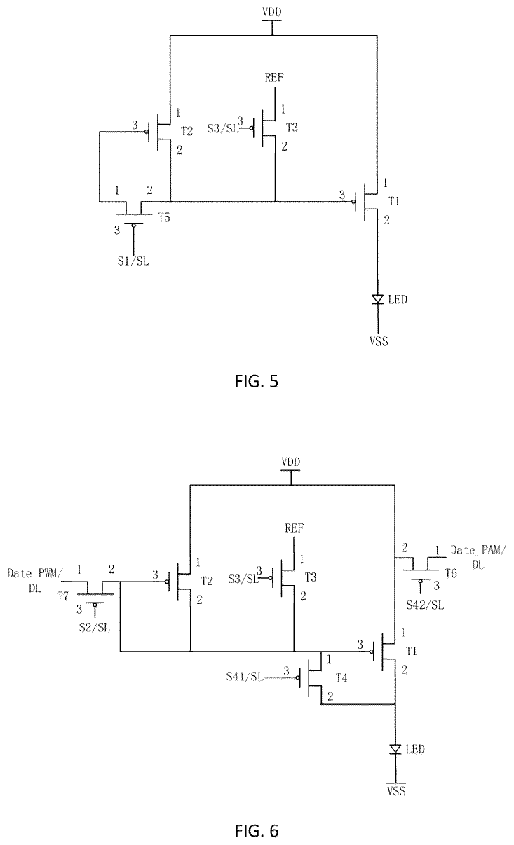

In some embodiments, as shown in FIG. 6, the pixel circuit can further include a sixth transistor T6 and a seventh transistor T7. The first electrode of the sixth transistor T6 can be configured to receive the first data signal Date_PAM. The second electrode of the sixth transistor T6 is connected to the first electrode of the first transistor T1. The gate electrode of the sixth transistor T6 can be configured to receive the first data writing control signal S42. The sixth transistor T6 can be configured to write the first data signal Date_PAM into the first electrode of the first transistor T1 in response to the first data writing control signal S42 received at the gate electrode of the sixth transistor T6.

The first electrode of the seventh transistor T7 can be configured to receive the second data signal Date_PWM. The second electrode of the seventh transistor T7 is connected to the gate electrode of the second transistor T2. The gate electrode of the seventh transistor T7 can be configured to receive the second data writing control signal S2. The seventh transistor T7 can be configured to write the second data signal Date_PWM to the gate electrode of the second transistor in response to the second data writing control signal S1 received at the gate electrode of the seventh transistor T7. In some embodiments, as shown in FIGS. 1 and 6, the first data writing control signal S42 and the second data writing control signal S2 are provided by the scan line SL, and the first data signal Date_PAM and the second data signal Date_PWM are provided by the data line DL.

In some embodiments, when the fourth transistor T4 is configured to perform threshold compensation for the first transistor T1, the seventh transistor T7 simultaneously writes the first data signal Date_PAM into the first electrode of the first transistor T1. The aforementioned first data signal Date_PAM is a PAM-modulated data signal that can adjust the brightness of the light-emitting element by adjusting the voltage amplitude of the input signal. In this embodiment, the working principle of the third transistor T3 is the same as in the above embodiments, and will not be repeated here.

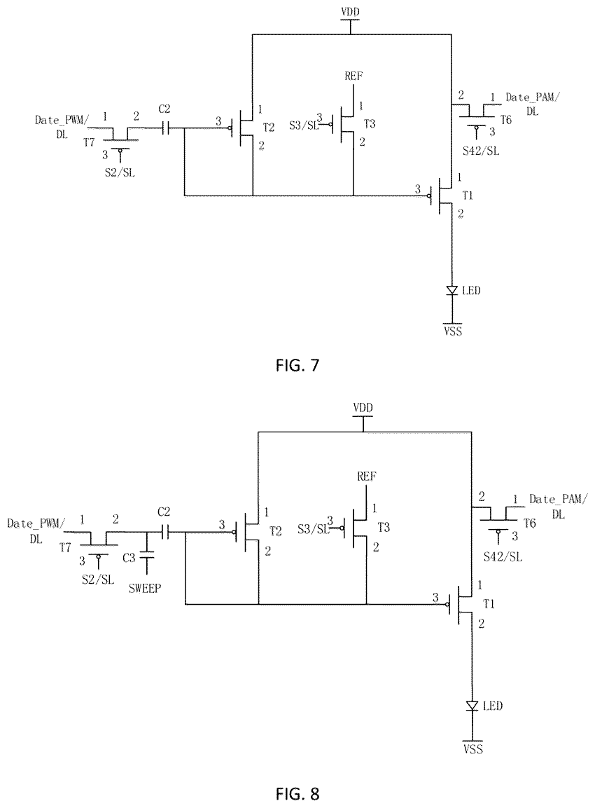

In some embodiments, as shown in FIG. 7, the pixel circuit can further include a second capacitor C2. The first electrode of the second capacitor C2 is connected to the second electrode of the seventh transistor T7, and the second electrode of the second capacitor C2 is connected to the second transistor T2. The second capacitor C2 can be configured to couple the second data signal Date_PWM written by the seventh transistor T7 to the second transistor T2. In this embodiment, the working principle of the third transistor T3 is the same as in the above embodiments, and will not be repeated here.

In some embodiments, as shown in FIG. 8, the pixel circuit can further include a third capacitor C3. The first electrode of the third capacitor C3 is connected to the gate electrode of the second transistor T2 through the second capacitor C2. The third capacitor C3 can be configured to couple the light emission duration control signal SWEEP to the second transistor T2 and control the turn-on and turn-off of the second transistor. The second transistor T2 provides a control signal to the first transistor T1 to control the light emission duration of the light-emitting element according to the control of the light emission duration control signal SWEEP.

In some embodiments, in the embodiment shown in FIG. 8, both the second transistor T2 and the first transistor T1 are P-type transistors, whose gate electrodes are turned on in response to a low potential, and the aforementioned light emission duration control signal SWEEP is an electrical signal with a gradually decreasing potential. At the initial moment of the light-emitting phase of the LED, the second transistor T2 is in the off state. The potential of the light emission duration control signal SWEEP gradually decreases, causing the second transistor T2 to turn on at a certain moment. Since the first electrode of the second transistor T2 is connected to the power supply signal VDD, when the second transistor T2 turns on, the high-potential power supply signal VDD will pull up the potential of the gate electrode of the first transistor T1 through the second electrode of the second transistor T2, causing the first transistor T1 to turn off and the LED to stop emitting light.

In some embodiments, both the second transistor T2 and the first transistor T1 are N-type transistors, whose gate electrodes can be turned on in response to a high potential, and the aforementioned light emission duration control signal SWEEP is an electrical signal with a gradually increasing potential. At the initial moment of the light-emitting phase of the light-emitting element LED, the second transistor T2 is in the off state. The light emission duration control signal SWEEP gradually rises, causing the second transistor T2 to turn on at a certain moment. Since the first electrode of the second transistor T2 is connected to the power supply signal VSS, when the second transistor T2 turns on, the low-potential power supply signal VSS will pull down the potential of the gate electrode of the first transistor T1 through the second electrode of the second transistor T2, causing the first transistor T1 to turn off and the LED to stop emitting light. In some embodiments, in this embodiment, the working principle of the third transistor T3 is the same as in the above embodiments, and will not be repeated here.

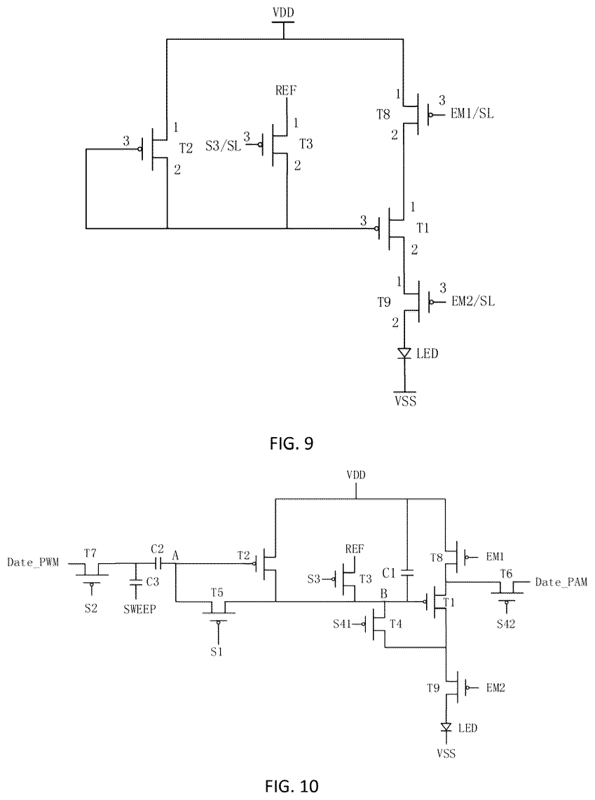

In some embodiments, as shown in FIG. 9, the pixel circuit can further include an eighth transistor T8 and a ninth transistor T9. The first electrode of the eighth transistor T8 can be configured to receive a power supply signal VDD, and the second electrode of the eighth transistor T8 is connected to the first electrode of the first transistor T1. The eighth transistor T8 can be configured to provide the power supply signal VDD received at the first electrode of the eighth transistor T8 to the first transistor T1 through the second electrode 2 of the eighth transistor T8 in response to the first driving control signal EM1 received at the gate electrode of the eighth transistor T8. The first electrode of the ninth transistor T9 is connected to the second electrode of the first transistor T1, and the second electrode of the ninth transistor T9 is connected to the light-emitting element LED. The ninth transistor T9 can be configured to provide the driving signal provided by the first transistor T1 received at the first electrode of the ninth transistor T9 to the light-emitting element LED through the second electrode 2 of the ninth transistor T9 in respond to the second driving control signal EM2 received at the gate electrode of the ninth transistor T9.

To prevent leakage current from the driving transistor from affecting the normal light emission of the light-emitting element, in the above embodiments, two control transistors are arranged in the driving circuit, so that the driving circuit can be turned off when the light-emitting element is not emitting light and turned on again during the light-emitting phase. In some embodiments, as shown in FIGS. 1 and 9, the first driving control signal EM1 and the second driving control signal EM2 are provided by the scan line SL. In this embodiment, the working principle of the third transistor T3 is the same as in the above embodiments, and will not be repeated here.

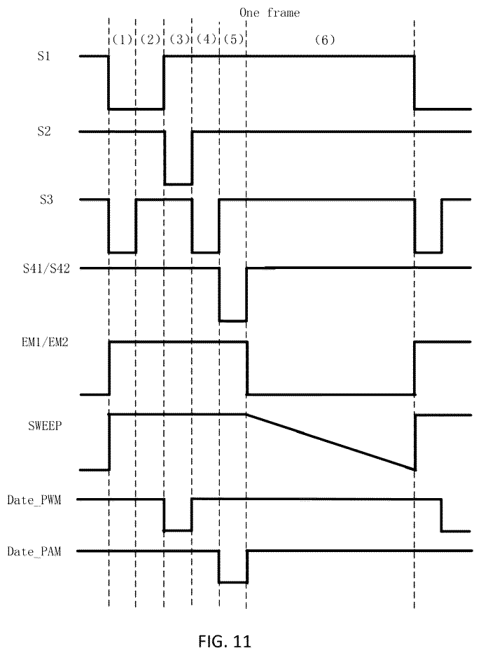

The overall working principle of the pixel circuit described above will be explained below with reference to a specific embodiment. As shown in FIG. 10, the pixel circuit can include a first transistor T1, a second transistor T2, a third transistor T3, a fourth transistor T4, a fifth transistor T5, a sixth transistor T6, a seventh transistor T7, an eighth transistor T8, a ninth transistor T9, a first capacitor C1, a second capacitor C2, and a third capacitor C3. The transistors and capacitors in the embodiment shown in FIG. 10 operate on the same principle as in embodiments described above, and the signals provided by the data lines and scan lines are also the same, so they will not be described again here.

In some embodiments, the first transistor T1 and the second transistor T2 can be reset by a third transistor T3, which directly reduces the number of devices in the display apparatus, saves the area occupied by the pixel circuit in the display panel, and effectively improves the pixel density and the resolution of the display panel. Furthermore, the pixel circuit shown in the embodiment of FIG. 10 does not exhibit transistor charging phenomenon, thus reducing the driving power consumption of the pixel circuit.

It should be noted that the transistor types shown in embodiments in FIG. 10 are examples and are not limited to P-type transistors. Those skilled in the art can select different types of transistors according to the actual situation and set the active potential of the gate signal accordingly, which will not be elaborated here.

Some embodiments of the present application provide another pixel circuit, the pixel circuit can be any one of the pixel circuits in the above embodiments and the accompanying drawings 2 to 10. The driving phases of the pixel circuit can sequentially include a first reset phase, a first compensation phase, a first data writing phase, a second reset phase, a second compensation phase, a second data writing phase, and a light-emitting phase. For the pixel circuit shown in embodiments of FIG. 2, the driving phases of the pixel circuit can include the following phases.

In the first reset phase, the reset control signal S3 is an active potential, the third transistor T3 is turned on and provides the reset signal REF to the gate electrode of the second transistor T2. The second transistor T2 is reset and turned on using the reset signal REF received at the gate electrode of the second transistor T2. In some embodiments, as shown in FIG. 2, the first transistor T1, the second transistor T2, and the third transistor T3 are all P-type transistors, and their gates are turned on in response to a low potential. Naturally, the above-mentioned active potential is low potential, and the reset signal REF is also low potential. Since the third transistor T3 is turned on, the reset signal REF with the low potential can be provided to the gate electrode of the second transistor T2 through the third transistor T3, thereby pulling down the gate potential of the second transistor T2, thereby resetting and turning on the second transistor T2.

In the second reset phase, the reset control signal S3 is an active potential, the third transistor T3 is turned on and provides the reset signal REF to the gate electrode of the first transistor T1. The first transistor T1 is reset and turned on using the reset signal REF received at the gate electrode of the first transistor T1. In some embodiments, since the reset signal REF is low potential, the third transistor T3 is turned on, the reset signal REF with the low potential can be provided to the gate electrode of the first transistor T1 through the third transistor T3, thereby pulling down the gate potential of the first transistor T1, thus resetting and turning on the first transistor T1.

In the light-emitting phase, the gate electrode of the first transistor T1 receives an active potential and is turned on, using the power signal VDD received at the first electrode of the first transistor T1 to provide a driving signal to the light-emitting element LED through the second electrode of the first transistor T1; and the gate electrode of the second transistor T2 receives an active potential and is turned on, using the power signal VDD received at the first electrode of the second transistor T2 to provide a control signal to the gate electrode of the first transistor T1 through the second electrode of the second transistor T2 to control the light emission duration of the light-emitting element LED. In some embodiments, after the first transistor T1 is turned on, it can provide driving signals of different amplitudes to the light-emitting element LED, thus realizing the PAM driving mode. The second transistor T2 can control the turn-on and turn-off of the first transistor T1 by applying a light emission duration control signal to the gate electrode of the first transistor T1, thereby controlling the time when the first transistor T1 provides a driving signal to the light-emitting element LED, thus realizing the PWM driving mode.

In some embodiments, the first transistor T1 and the second transistor T2 can be reset by a third transistor T3, which reduces the number of devices in the display apparatus, saves the area occupied by the pixel circuit in the display panel, and effectively improves the pixel density and the resolution of the display panel.

In some embodiments, as shown in FIG. 4, during the second compensation phase and the second data writing phase, the first compensation control signal S41 is at an active potential, the reset control signal S3 is at an inactive potential, the fourth transistor T4 is turned on and the fourth transistor T4 provides threshold compensation to the first transistor T1, and the first transistor T1 receives the threshold compensation provided by the fourth transistor T4. In some embodiments, when the reset control signal S3 is at an inactive potential, the third transistor T3 is turned off, the first compensation control signal S41 is at an active potential, and the fourth transistor T4 is turned on, thereby compensating the potential of the second electrode of the first transistor T1 to the gate electrode of the first transistor T1, thus completing the threshold compensation of the first transistor T1.

In some embodiments, the principles of the other driving phases are the same as in the above embodiments, and will not be repeated here.

In some embodiments, as shown in FIG. 5, during the first reset phase, the reset control signal S3 and the first compensation and reset control signal S1 are both at active potentials. The third transistor T3 and the fifth transistor T5 are turned on. The third transistor T3 provides the reset signal REF to the second electrode of the fifth transistor T5. The fifth transistor T5 provides the reset signal REF to the gate electrode of the second transistor T2. The second transistor T2 is reset and turned on using the reset signal REF received at the gate electrode of the second transistor T2.

In the first compensation phase, the reset control signal S3 is at an inactive potential, the first compensation and reset control signal S1 is at an active potential, the fifth transistor T5 is turned on and provides threshold compensation to the second transistor T2, and the second transistor T2 receives the threshold compensation provided by the fifth transistor T5. In some embodiments, when the third transistor T3 needs to reset the second transistor T2, the reset control signal S3 and the first compensation and reset control signal S1 are at active potentials. The third transistor T3 is turned on, providing the reset signal REF to the second electrode of the fifth transistor T5. The fifth transistor T5 is turned on, providing the reset signal REF provided by the third transistor T3 to the gate electrode of the second transistor T2. When threshold compensation is required for the second transistor T2, only the first compensation and reset control signal S1 is at an active potential, the third transistor T3 is turned off, and the fifth transistor T5 is turned on, so that the potential at the second electrode of the second transistor T2 is compensated to the gate electrode of the second transistor T2, thereby completing the threshold compensation for the second transistor T2.

In some embodiments, the principles of the other driving phases are the same as in the above embodiments, and will not be repeated here.

In some embodiments, as shown in FIG. 6, during the first data writing phase, the second data writing control signal S2 is at an active potential, while the first compensation control signal S41, the first data writing control signal S42, and the reset control signal S3 are at inactive potentials. The seventh transistor T7 is turned on and writes the second data signal Date_PWM to the gate electrode of the second transistor T2. In some embodiments, since the two driving transistors need to write data at different phases, the third transistor T3, the fourth transistor T4, and the sixth transistor T6 need to remain off when the seventh transistor T7 is turned on and writes the second data signal Date_PWM to the gate electrode of the second transistor T2. Furthermore, since the second data signal Date_PWM is written to the gate electrode of the second transistor T2, threshold compensation cannot be performed on the second transistor at the same time; otherwise, the threshold compensation of the gate electrode of the second transistor will be interfered with by the second data signal Date_PWM.

During the second compensation phase and the second data writing phase, the first compensation control signal S41 and the first data writing control signal S42 are at active potentials, the reset control signal S3 and the second data writing control signal S2 are at inactive potentials, the fourth transistor T4 and the sixth transistor T6 are turned on, the fourth transistor T4 provides threshold compensation to the first transistor T1, and the sixth transistor T6 writes the first data signal Date_PAM to the first electrode of the first transistor T1. The first transistor T1 receives the threshold compensation provided by the fourth transistor T4 and the first data signal Date_PAM provided by the sixth transistor T6. In some embodiments, since the two driving transistors need to write data at different phases, the third transistor T3 and the seventh transistor T7 need to remain off when the sixth transistor T6 is turned on and writes the first data signal Date_PAM to the first electrode of the first transistor T1. Furthermore, since the first data signal Date_PAM is written to the first electrode of the first transistor T1, and the threshold compensation is performed on the gate electrode of the first transistor T1, data writing and threshold compensation can be performed simultaneously for the first transistor.

In some embodiments, the principles of the other driving phases are the same as in the above embodiments, and will not be repeated here.

Combined with FIG. 10, the driving method for each phase of the pixel circuit will be described below. The timing diagram of each signal in the circuit corresponding to the embodiment of FIG. 10 is shown in FIG. 11. The driving phase of the pixel circuit shown in the embodiments of FIG. 10 can include a first reset phase (1), a first compensation phase (2), a first data writing phase (3), a second reset phase (4), a second compensation phase and a second data writing phase (5), and a light-emitting phase (6). In the pixel circuit shown in the embodiments of FIG. 10, each transistor can be a P-type transistor, and each transistor can be turned on in response to the gate electrode being a low potential, so the active potential is a low potential.

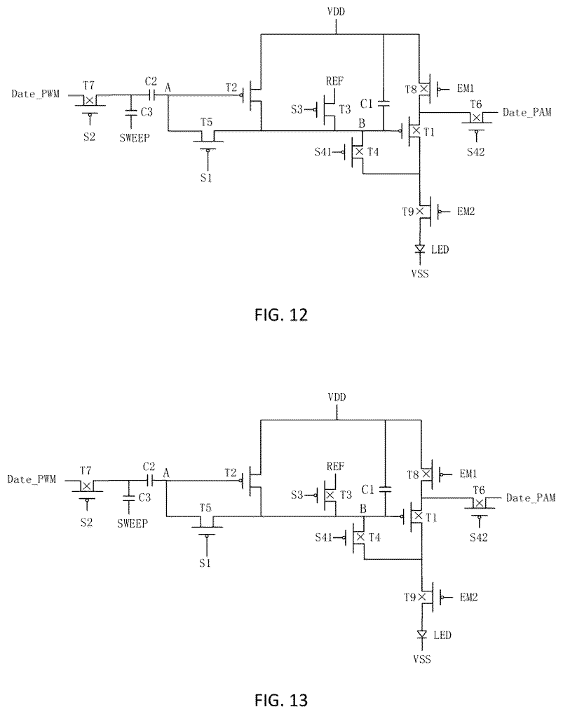

In the first reset phase, corresponding to phase (1) in FIG. 11, the reset control signal S3, the first compensation and reset control signal S1 is a low potential, and other signals remain a high potential, as shown in FIG. 12 (in FIG. 12, transistors marked with “x” are in the turned-off state, which does not mean that the transistor does not exist, and unmarked transistors are in the turned-on state. The same applies to the figures of other embodiments, and will not be repeated). Since the reset control signal S3, the first compensation and reset control signal S1 are at low potentials, the fifth transistor T5 and the third transistor T3 are turned on, and other transistors are turned off. Since the fifth transistor T5 and the third transistor T3 are turned on, the first transistor T1 and the fourth transistor T4 are turned off. The reset signal REF can first pass through the third transistor T3 and then through the fifth transistor T5 to charge the second capacitor C2. The node A of the gate electrode of the second transistor T2 is reset to the REF potential. At the same time, as shown in FIG. 10, since the REF potential is at a low potential, the second transistor T2 is turned on in response to the REF potential (low potential) of the gate electrode of the second transistor T2.

In the first compensation phase, corresponding to phase (2) in FIG. 11, the first compensation and reset control signal S1 is at a low potential, while other signals remain at a high potential. As shown in FIG. 13, since the first compensation and reset control signal S1 is at a low potential, the fifth transistor T5 is turned on, while other transistors are turned off. Since the second transistor T2 is in the turned-on state at this time, the power supply signal VDD can reach the second electrode of the second transistor T2. The fifth transistor T5 can use the potential of the second electrode of the second transistor T2 to perform threshold voltage compensation for the gate electrode of the second transistor T2. That is, VDD is written to node A of the gate electrode of the second transistor T2 through T2 and T5. At this time, the potential of node A is VA=VDD+Vth.

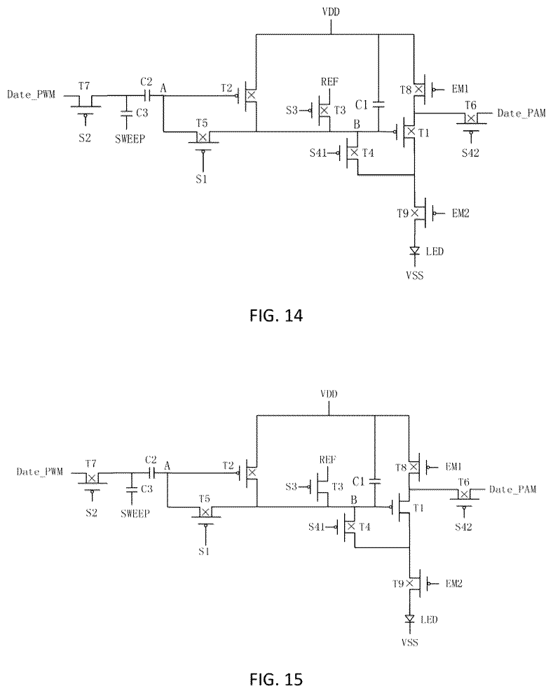

In the first data writing phase, corresponding to phase (3) in FIG. 11, the second data writing control signal S2 and the second data signal Date_PWM are at the low potential, while other signals remain high potential. As shown in FIG. 14, since the second data writing control signal S2 is at the low potential, the seventh transistor T7 is turned on. Since the seventh transistor T7 is turned on, the second data signal Date_PWM can pass through the seventh transistor T7 and be coupled to node A of the gate electrode of the second transistor T2 by the second capacitor C2. At this time, the potential of node A is VA=V(Date_PWM)+VDD+Vth.

In the second reset phase, corresponding to phase (4) in FIG. 11, the reset control signal S3 is at the low potential, while other signals remain high. As shown in FIG. 15, since the reset control signal S3 is at the low potential, the third transistor T3 is turned on, and the other transistors are turned off. Since the third transistor T3 is turned on, the reset signal REF can charge the first capacitor C1 through the third transistor T3. At the same time, node B of the gate electrode of the first transistor T1 is reset to the REF potential. In embodiments shown in FIG. 10, the REF potential is a low potential, and the first transistor T1 turns on in response to the REF potential (low potential) of the gate electrode of the first transistor T1. It should be noted that although the third transistor T3 is also turned on during the first reset phase, after the first compensation phase and the first data writing phase, the power supply signal VDD reaches node B through the turned-on second transistor T2, so that the potential of node B is no longer the REF potential. Therefore, node B at the gate electrode of the first transistor T1 needs to be reset again during the second reset phase.

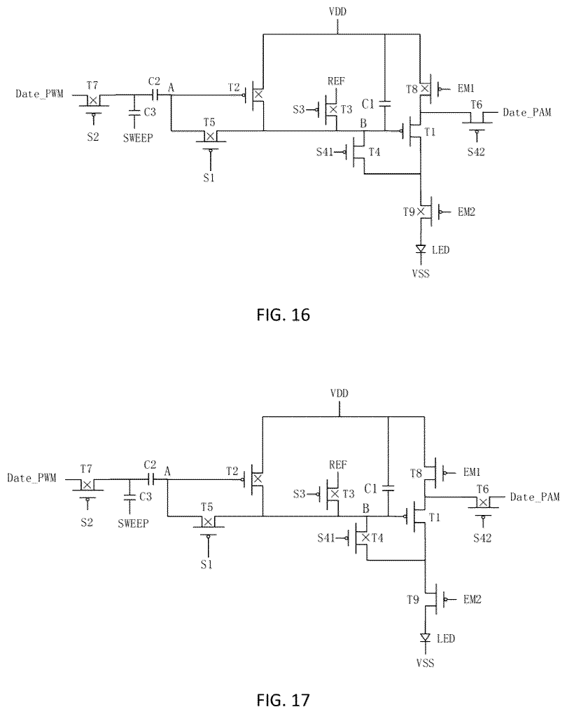

In the second compensation phase and the second data writing phase, corresponding to phase (5) in FIG. 11, the first compensation control signal S41 and the first data writing control signal S42 are at the low potential, while other signals remain high potential. As shown in FIG. 16, since the first compensation control signal S41 and the first data writing control signal S42 are the low potential, the fourth transistor T4 and the sixth transistor T6 can be turned on. Since the sixth transistor T6 is turned on and the eighth transistor T8 is turned off, the first data signal Date_PAM can be written to the first electrode of the first transistor T1 through the sixth transistor T6. At the same time, since the first transistor T1 and the fourth transistor T4 are turned on, the first data signal Date_PAM can continue to pass through T1 and T4 to compensate for the threshold voltage of the gate electrode of the first transistor T1. At this time, the node B potential VB=V(Date_PAM)+Vth.

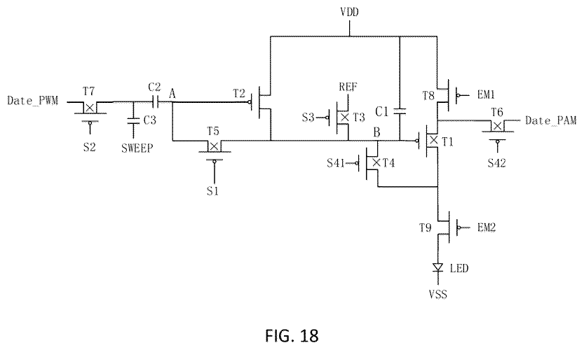

In the light-emitting phase, corresponding to phase (6) in FIG. 11, the first driving control signal EM1 and the second driving control signal EM2 become are at the low potential, the light emission duration control signal SWEEP potential gradually decreases from high potential, and other signals remain high potential. As shown in FIG. 17, since the first driving control signal EM1 and the second driving control signal EM2 are at the low potential, the eighth transistor T8 and the ninth transistor T9 are turned on, while the fourth transistor T4 is turned off. At the same time, since the first transistor T1 remains turned-on during the previous second compensation phase and the second data writing phase, the power supply signal VDD drives the light-emitting element LED to start emitting light through T8, T1 and T9. As the potential of the light emission duration control signal SWEEP decreases, coupled with the coupling effect of C2 and C3, the potential VA of node A gradually decreases from V(Date_PWM)+VDD+Vth until the second transistor T2 is in the turned-on state. As shown in FIG. 18, after the second transistor T2 is turned on, the high-potential VDD signal can charge the first capacitor C1 through the second transistor T2. At the same time, the potential of node B at the gate electrode of the first transistor T1 gradually increases until the first transistor T1 is turned off. At this time, the light-emitting element LED stops emitting light.

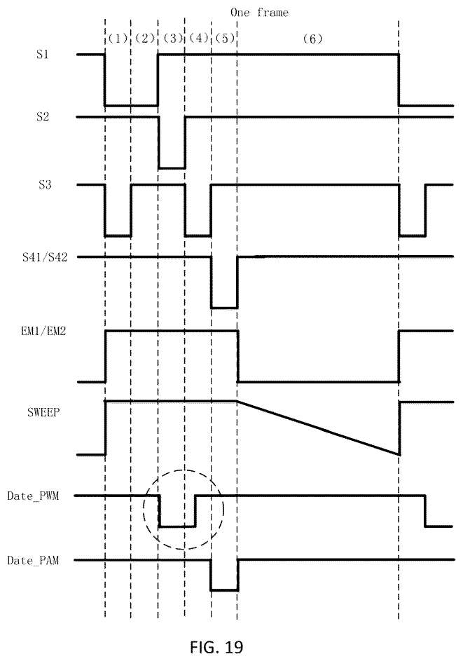

In some embodiments, if the second data signal Date_PWM stops writing at the same time that the seventh transistor T7 is turned off, then the second capacitor C2 and the third capacitor C3 can couple part of the second data signal Date_PWM, so that the second data signal Date_PWM cannot be completely written to the second transistor T2. Therefore, in some embodiments, as shown in the timing diagram of FIG. 19, the rising edge of the low potential of the second data signal Date_PWM needs to lag slightly behind the rising edge of the low potential of the second data writing control signal S2.

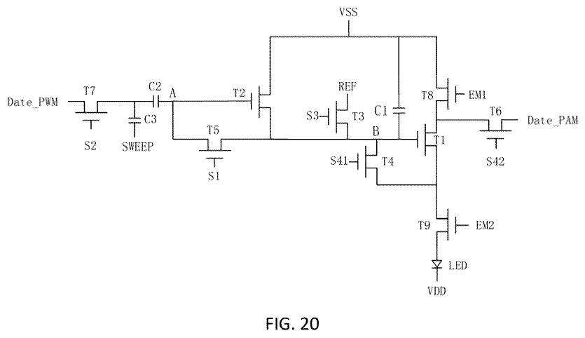

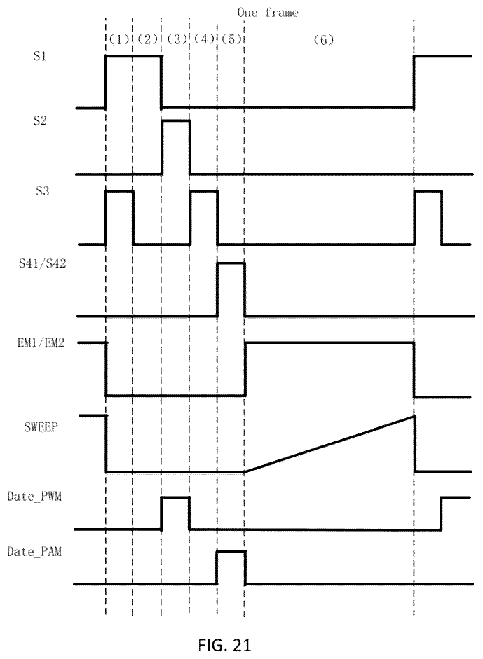

In some embodiments, such as the pixel circuit shown in FIG. 20, each transistor is an N-type transistor, and each transistor can be turned on in response to the gate electrode of each transistor being a high potential, that is, the active potential is a high potential. The timing diagram of each signal in the circuit corresponding to embodiments of FIG. 20 is shown in FIG. 21.

In the first reset phase, corresponding to phase (1) in FIG. 21, the reset control signal S3 and the first compensation and reset control signal S1 are at the high potential, while other signals remain the low potential. Since the reset control signal S3 and the first compensation and reset control signal S1 are at the high potential, the fifth transistor T5 and the third transistor T3 are turned on, while other transistors are turned off. The reset signal REF can first pass through T3 and then through T5 to charge the second capacitor C2. At the same time, node A of the gate electrode of the second transistor T2 is reset to the REF potential. For embodiments shown in FIG. 20, the REF potential is the high potential, and the second transistor T2 turns on in response to the REF potential (high potential) of the gate electrode of the second transistor T2.

In the first compensation phase, corresponding to phase (2) in FIG. 21, the first compensation and reset control signal S1 is at a high potential, while other signals remain at a low potential. Since the first compensation and reset control signal S1 is at a high potential, the fifth transistor T5 is turned on, while other transistors are turned off. Since the second transistor T2 is in the turned-on state at this time, the power supply signal VSS can reach the second electrode of the second transistor T2. The fifth transistor T5 can use the potential of the second electrode of the second transistor T2 to perform threshold voltage compensation for the gate electrode of the second transistor T2. That is, VSS is written to node A of the gate electrode of the second transistor T2 through T2 and T5. At this time, the potential of node A is VA=VSS+Vth.

In the first data writing phase, corresponding to phase (3) in FIG. 21, the second data writing control signal S2 and the second data signal Date_PWM are at the high potential, while other signals remain the low potential. Since the second data writing control signal S2 is at the high potential, the seventh transistor T7 is turned on, and the second data signal Date_PWM can pass through the seventh transistor T7 and be coupled to node A of the gate electrode of the second transistor T2 by the second capacitor C2. At this time, the potential of node A is VA=V(Date_PWM)+VSS+Vth.

In the second reset phase, corresponding to phase (4) in FIG. 21, the reset control signal S3 is at the high potential, while other signals remain the low potential. Since the reset control signal S3 is at the high potential, the third transistor T3 is turned on, and other transistors are turned off. The reset signal REF can charge the first capacitor C1 through the third transistor T3. At the same time, node B of the gate electrode of the first transistor T1 is reset to the REF potential. For the embodiment shown in FIG. 20, the REF potential is the high potential, and the first transistor T1 is turned on in response to the REF potential (high potential) of the gate electrode of the first transistor T1. It should be noted that although the third transistor T3 is also turned on during the first reset phase, after the first compensation phase and the first data writing phase, the power signal VSS reaches node B through the turned-on second transistor T2, so that the potential of node B is no longer the REF potential. Therefore, node B at the gate electrode of the first transistor T1 needs to be reset again during the second reset phase.

In the second compensation phase and the second data writing phase, corresponding to phase (5) in FIG. 21, the first compensation control signal S41 and the first data writing control signal S42 are at the high potential, while other signals remain the low potential. Since the first compensation control signal S41 and the first data writing control signal S42 are at the high potential, the fourth transistor T4 and the sixth transistor T6 are turned on, and the first data signal Date_PAM can be written to the first electrode of the first transistor T1 through the sixth transistor T6. At the same time, since the first transistor T1 and the fourth transistor T4 are turned on, the first data signal Date_PAM can continue to pass through T1 and T4 to compensate for the threshold voltage of the gate electrode of the first transistor T1. At this time, the node B potential VB=V(Date_PAM)+Vth.

In the light-emitting phase, corresponding to phase (6) in FIG. 21, the first driving control signal EM1 and the second driving control signal EM2 are at the high potential, the light emission duration control signal SWEEP potential gradually increases from low potential, and other signals remain the low potential. Since the first driving control signal EM1 and the second driving control signal EM2 are at the high potential, the eighth transistor T8 and the ninth transistor T9 are turned on. At the same time, since the first transistor T1 remains turned-on during the previous second compensation phase and the second data writing phase, the power supply signal VSS can drive the light-emitting element LED to start emitting light through T8, T1 and T9. As the potential of the light emission duration control signal SWEEP increases, coupled with the coupling effect of C2 and C3, the potential VA of node A gradually increases from V(Date_PWM)+VSS+Vth until the second transistor T2 is in the turned-on state. After the second transistor T2 is turned on, the low-potential VSS signal can charge the first capacitor C1 through the second transistor T2. At the same time, the node B potential at the gate electrode of the first transistor T1 gradually decreases until the first transistor T1 is turned off, at which point the light-emitting element LED stops emitting light.

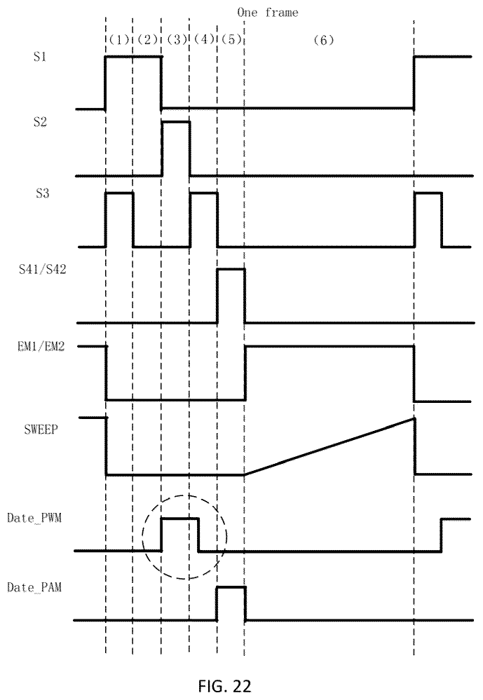

In some embodiments, if the second data signal Date_PWM stops writing at the same time that the seventh transistor T7 is turned off, then the second capacitor C2 and the third capacitor C3 can couple part of the second data signal Date_PWM, so that the second data signal Date_PWM cannot be completely written to the second transistor T2. Therefore, in some embodiments, as shown in the timing diagram of FIG. 22, the falling edge of the low potential of the second data signal Date_PWM needs to lag slightly behind the falling edge of the low potential of the second data writing control signal S2.

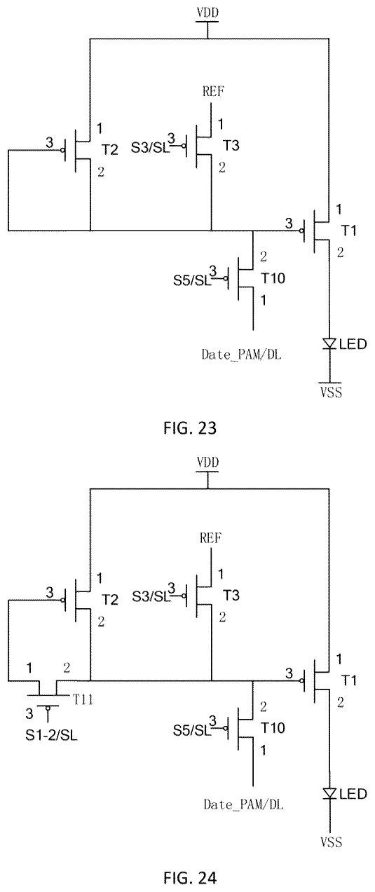

According to some embodiments of the present application, as shown in FIG. 23, the pixel circuit can further include a tenth transistor T10 compared to the pixel circuit shown in FIG. 2. In some embodiments, as shown in FIG. 23, the third transistor T3 is a P-type transistor and turns on in response to a low potential. The active potential of the reset control signal S3 is a low potential. When the reset control signal S3 is at the low potential, the third transistor T3 turns on, and the reset signal REF can be provided to the second electrode of the third transistor T3 through the first electrode of the third transistor T3. In some embodiments, as shown in FIGS. 1 and 23, the reset control signal S3 can be provided by the scan line SL, the reset signal REF can be provided by the data line DL or connected to a fixed potential.

The first electrode of the tenth transistor T10 can be configured to receive the third data signal Date_PAM, the second electrode of the tenth transistor T10 is connected to the gate electrode of the first transistor T1, and the gate electrode of the tenth transistor T10 can be configured to receive the third data writing control signal S5. The tenth transistor T10 can be configured to write the third data signal Date_PAM into the gate electrode of the first transistor T1 in response to the third data writing control signal S5 received at the gate electrode of the tenth transistor T10. The aforementioned third data signal Date_PAM is a PAM-modulated data signal that can adjust the brightness of the light-emitting element by adjusting the voltage amplitude of the input signal. In some embodiments, when the third data writing control signal S5 is at an active potential, the tenth transistor T10 is turned on, and the third data signal Date_PAM can be provided to the second electrode of the tenth transistor T10 through the first electrode of the tenth transistor T10. In some embodiment, as shown in FIG. 23, the tenth transistor T10 can be a P-type transistor and turn on in response to a low potential. The active potential of the third data writing control signal S5 is the low potential. When the third data writing control signal S5 is the low potential, the tenth transistor T10 can be turned on, and the third data signal Date_PAM can be provided to the second electrode of the tenth transistor T10 through the first electrode of the tenth transistor T10.

In some embodiments, as shown in FIGS. 1 and 23, the third data writing control signal S5 can be provided by the scan line SL, and the third data signal Date_PAM can be provided by the data line DL.

In some embodiments, as shown in FIG. 24, the pixel circuit shown in FIG. 23 can further include an eleventh transistor T11. In some embodiments, the first electrode of the eleventh transistor T11 is connected to the gate electrode of the second transistor T2, the second electrode of the eleventh transistor T11 is connected to the second electrode of the second transistor T2 and the second electrode of the third transistor T3, and the gate electrode of the eleventh transistor T11 is configured to receive the second compensation and reset control signal S1-2. The eleventh transistor T11 is configured to provide the reset signal REF provided by the third transistor T3 to the gate electrode of the second transistor T2 in response to the second compensation and reset control signal S1-2 received through the gate electrode of the eleventh transistor T11. The eleventh transistor T11 is further configured to provide threshold compensation for the second transistor T2 in response to the second compensation and reset control signal S1-2 received through the gate electrode of the eleventh transistor T11. In some embodiments, when threshold compensation is required for the second transistor T2, the second compensation and reset control signal S1-2 is at an active potential, the eleventh transistor T11 is turned on, and the potential of the second electrode of the second transistor T2 is compensated to the gate electrode of the second transistor T2, thereby completing the threshold compensation for the second transistor T2.

In some embodiments, as shown in FIG. 24, both the third transistor T3 and the eleventh transistor T11 can be P-type transistors and turn on in response to a low potential. The active potentials of the reset control signal S3 and the second compensation and reset control signal S1-2 are both at the low potential. When the third transistor T3 is turned on to reset the second transistor T2, the second compensation and reset control signal S1-2 is at the low potential, the eleventh transistor T11 is turned on, and the reset signal REF provided by the third transistor T3 is provided to the gate electrode of the second transistor T2. When threshold compensation is required for the second transistor T2, the second compensation and reset control signal S1-2 is at the low potential, the eleventh transistor T11 is turned on, and the potential of the second electrode of the second transistor T2 is compensated to the gate electrode of the second transistor T2, thereby completing the threshold compensation of the second transistor T2. Thus, in the above embodiments of the present application, by adding an eleventh transistor T11 between the gate electrode of the second transistor T2 and the second electrode of the second transistor T2, threshold compensation can be performed on the second transistor T2, thereby achieving a better display effect. Meanwhile, the eleventh transistor T11 is arranged between the gate electrode of the second transistor T2 and the second electrode of the third transistor T3, and can work with the third transistor T3 to reset the second transistor T2, thus eliminating the need to provide an additional reset transistor for the second transistor T2.

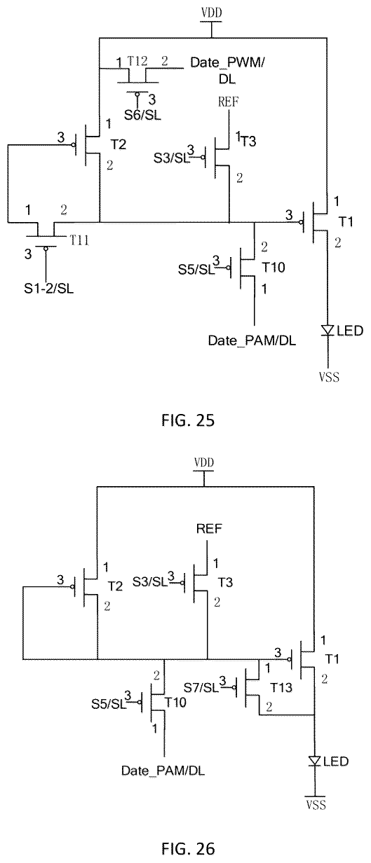

In some embodiments, as shown in FIG. 25, the pixel circuit shown in FIG. 24 can further include a twelfth transistor T12, the first electrode of the twelfth transistor T12 is connected to the first electrode of the second transistor T2, the second electrode of the twelfth transistor T12 is configured to receive a fourth data signal Date_PWM, and the gate electrode of the twelfth transistor T12 is configured to receive a fourth data writing control signal S6. The twelfth transistor T12 can be configured to write the fourth data signal Date_PWM to the first electrode of the second transistor T2 in response to the fourth data writing control signal S6 received at the gate electrode of the twelfth transistor T12. In some embodiments, when the second transistor T2 is turned on, the fourth data signal Date_PWM is transmitted to the second electrode of the second transistor T2. In some embodiments, when the fourth data writing control signal S6 is at an active potential, the twelfth transistor T12 is turned on, and the fourth data signal Date_PWM can be provided to the first electrode of the twelfth transistor T12 through the second electrode of the twelfth transistor T12. In some embodiment, as shown in FIG. 25, the twelfth transistor T12 is a P-type transistor and turns on in response to a low potential. The active potential of the fourth data writing control signal S6 is a low potential. When the fourth data writing control signal S6 is at the low potential, the twelfth transistor T12 turns on, and the fourth data signal Date_PWM can be provided to the first electrode of the twelfth transistor T12 through the second electrode of the twelfth transistor T12.

In some embodiments, as shown in FIGS. 1 and 25, the fourth data writing control signal S6 can be provided by the scan line SL, and the fourth data signal Date_PWM can be provided by the data line DL.

The eleventh transistor T11 can further be configured to provide threshold compensation for the second transistor T2 in response to the second compensation and reset control signal S1-2 received through the gate electrode of the eleventh transistor T11, while providing the fourth data signal Date_PWM transmitted to the second electrode of the second transistor T2 to the gate electrode of the second transistor T2. After the fourth data signal Date_PWM is written into the gate electrode of the second transistor T2, it can coordinately control the turned-on time of the second transistor T2, thereby enabling the second transistor T2 to provide a control signal to the first transistor T1 to control the light emission duration of the light-emitting element LED.

In some embodiments, the working principle of the third transistor T3 is the same as in the previous embodiments, and will not be repeated here.

In some embodiments, as shown in FIG. 26, the pixel circuit shown in FIG. 23 can further include a thirteenth transistor T13, the first electrode of the thirteenth transistor T13 is connected to the gate electrode of the first transistor T1, the second electrode of the thirteenth transistor T13 is connected to the second electrode of the first transistor T1, and the gate electrode of the thirteenth transistor T13 is configured to receive a third compensation control signal S7. In some embodiments, as shown in FIGS. 1 and 5, the aforementioned third compensation control signal S7 can be provided by the scan line SL.

The thirteenth transistor T13 can be configured to provide threshold compensation for the first transistor T1 in response to the third compensation control signal S7 received at the gate electrode of the thirteenth transistor T13. In some embodiments, when the third compensation control signal S7 is at an active potential, the thirteenth transistor T13 is turned on, compensating the potential at the second electrode of the first transistor T1 to the gate electrode of the first transistor T1, thereby completing the threshold compensation of the first transistor T1. In some embodiment shown in FIG. 26, the thirteenth transistor T13 can be a P-type transistor and turns on in response to a low potential. The active potential of the third compensation control signal S7 is the low potential. When the third compensation control signal S7 is at the low potential, the thirteenth transistor T13 turns on, compensating the potential of the second electrode of the first transistor T1 to the gate electrode of the first transistor T1, thereby completing the threshold compensation of the first transistor T1. Thus, in the above embodiments of the present application, by adding a thirteenth transistor T13 between the gate electrode of the first transistor T1 and the second electrode of the first transistor T1, threshold compensation can be performed on the first transistor T1, thereby achieving a better display effect.

In some embodiment, the working principle of the third transistor T3 is the same as in the above embodiments, and will not be repeated here.

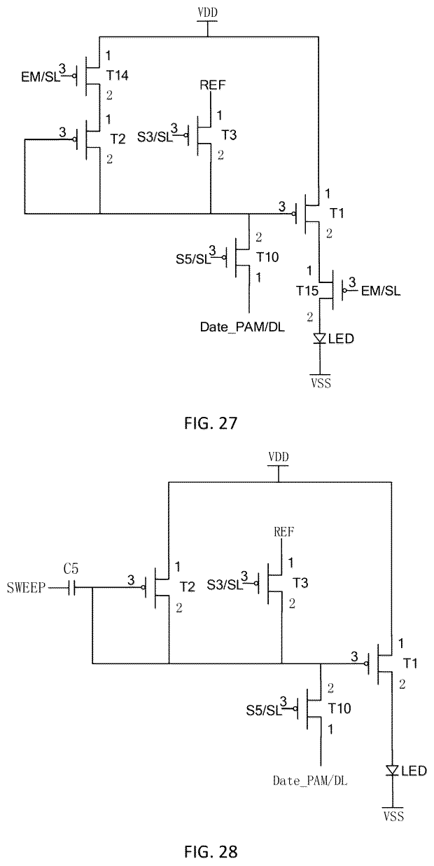

In some embodiments, as shown in FIG. 27, the pixel circuit can further include a fourteenth transistor T14 and a fifteenth transistor T15. The first electrode of the fourteenth transistor T14 can be configured to receive a power supply signal VDD, the second electrode of the fourteenth transistor T14 is connected to the first electrode of the second transistor T2 and the first electrode of the twelfth transistor T12, and the gate electrode of the fourteenth transistor T14 can be configured to receive a third driving control signal EM. The fourteenth transistor T14 can be configured to provide the power supply signal VDD to the first electrode of the second transistor T2 in response to the driving control signal EM received at the gate electrode of the fourteenth transistor T14. In some embodiments, when the third driving control signal EM is at an active potential, the fourteenth transistor T14 is turned on, and the power supply signal VDD can be provided to the first electrode of the second transistor T2 through the fourteenth transistor T14. In the embodiment shown in FIG. 27, the fourteenth transistor T14 can be a P-type transistor and turns on in response to a low potential. The active potential of the driving control signal EM is the low potential. When the third driving control signal EM is at the low potential, the fourteenth transistor T14 turns on, and the power supply signal VDD can be provided to the first electrode of the second transistor T2 through the fourteenth transistor T14.

The first electrode of the fifteenth transistor T15 is connected to the second electrode of the first transistor T1, the second electrode of the fifteenth transistor T15 is connected to the light-emitting element LED, and the gate electrode of the fifteenth transistor T15 can be configured to receive the fourth driving control signal EM. The fifteenth transistor T15 can be configured to provide the driving signal provided by the first transistor T1 to the light-emitting element LED in response to the fourth driving control signal EM received at the gate electrode of the fifteenth transistor T15. In some embodiments, when the fourth driving control signal EM is at an active potential, the fifteenth transistor T15 is turned on, and the driving signal can be provided to the light-emitting element LED through the fifteenth transistor T15. In some embodiments, as shown in FIG. 27, the fifteenth transistor T15 can be a P-type transistor and turns on in response to a low potential. The active potential of the fourth driving control signal EM is the low potential. When the driving control signal EM is at the low potential, the fifteenth transistor T15 turns on, and the driving signal can be provided to the light-emitting element LED through the fifteenth transistor T15. In some embodiments, as shown in FIGS. 1 and 27, the aforementioned fourth driving control signal EM can be provided by the scan line SL.

In some embodiments, two control transistors, namely the fourteenth transistor and the fifteenth transistor, can be set on the driving circuit, so that the driving circuit can be turned off when the light-emitting element is not emitting light and turned on again during the light-emitting phase, so as to avoid the leakage current generated by the driving transistor affecting the normal light emission of the light-emitting element. In some embodiments, the fourteenth transistor T14 and the fifteenth transistor T15 are turned on during the light-emitting phase. The driving signal provided by the first transistor T1 can drive the light-emitting element LED to emit light through the fifteenth transistor T15. At the same time, the power supply signal VDD reaches the first electrode of the second transistor T2 through the turned-on fourteenth transistor T14. When the second transistor T2 controls the light emission duration of the light-emitting element LED, the second transistor T2 turns on, allowing the power supply signal to reach the gate electrode of the first transistor T1 through the second transistor T2, causing the first transistor T1 to turn off.

In some embodiments, the working principle of the third transistor T3 is the same as in the above embodiments, and will not be repeated here.

In some embodiments, as shown in FIG. 28, the pixel circuit shown in FIG. 23 can further include a fifth capacitor C5. The first electrode of the fourth capacitor C4 can be connected to the gate electrode of the second transistor T2, and the second electrode can be configured to receive the light emission duration control signal SWEEP. The fifth capacitor C5 can be configured to couple the light emission duration control signal SWEEP to the gate electrode of the second transistor T2 and thereby control the turned-on and turn-off of the second transistor T2. The second transistor T2 then provides a control signal to the first transistor T1 to control the light emission duration of the light-emitting element LED according to the control of the light emission duration control signal SWEEP. In some embodiments, as shown in FIG. 28, both the second transistor T2 and the first transistor T1 can be P-type transistors, the first transistor T1 can be P-type transistors can be turned on in response to the low potential, and the aforementioned light emission duration control signal SWEEP is an electrical signal with a gradually decreasing potential. At the initial moment of the light-emitting phase of the LED, the second transistor T2 is in the turned-off state, and the potential of the light emission duration control signal SWEEP gradually decreases, so that the second transistor T2 is turned on at a certain moment. Since the first electrode of the second transistor T2 can receive the power supply signal VDD during the light-emitting phase, when it is turned on, the high-potential power supply signal VDD can pull up the potential of the gate electrode of the first transistor T1 through the second electrode of the second transistor T2, causing the first transistor T1 to turn off, and the LED stops emitting light.

In some embodiments, both the second transistor T2 and the first transistor T1 can be N-type transistors, the second transistor T2 and the first transistor T1 can be turned on in response to a high potential, and the aforementioned light emission duration control signal SWEEP is an electrical signal with a gradually increasing potential. At the initial moment of the light-emitting phase of the LED, the second transistor T2 is in the turned-off state, and the potential of the light emission duration control signal SWEEP gradually increases, so that the second transistor T2 turns on at a certain moment. Since the first electrode of the second transistor T2 can receive the power supply signal VSS during the light-emitting phase, when it turns on, the low-potential power supply signal VSS can pull down the potential of the gate electrode of the first transistor T1 through the second electrode of the second transistor T2, so that the first transistor T1 turns off and the LED stops emitting light.

In this embodiment, the working principle of the third transistor T3 is the same as in the above embodiments, and will not be repeated here.

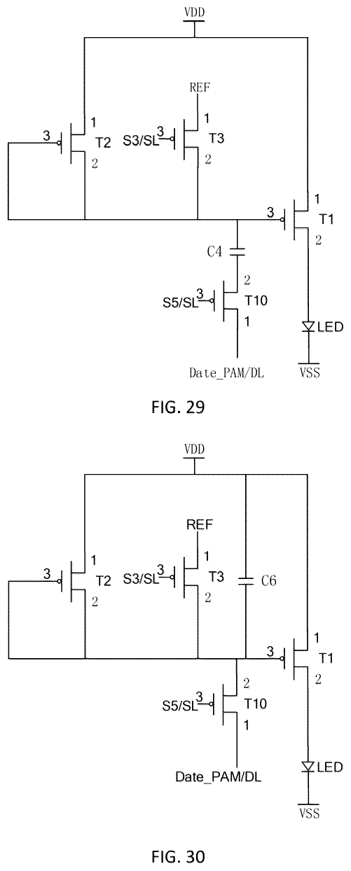

In some embodiments, as shown in FIG. 29, the pixel circuit shown in FIG. 23 can further include a fourth capacitor C4. The first electrode of the fourth capacitor C4 is connected to the second electrode of the tenth transistor T10, and the first electrode of the fourth capacitor C4 can be configured to receive the third data signal Date_PAM; the second electrode of the fourth capacitor C4 is connected to the gate electrode of the first transistor T1. The fifth capacitor C5 can be configured to couple the third data signal Date_PAM written by the tenth transistor T10 to the first transistor T1.

In this embodiment, the working principle of the third transistor T3 is the same as in the above embodiments, and will not be repeated here.

In some embodiments, as shown in FIG. 30, the pixel circuit shown in FIG. 23 can further include a sixth capacitor C6, the first electrode of the sixth capacitor C6 is connected to the gate electrode of the first transistor T1, and the second is configured to receive the power supply signal VDD. In some embodiments, the third transistor T3 can reset the potential at the gate electrode of the first transistor T1 to the reset voltage by charging the sixth capacitor C6 connected to the gate electrode of the first transistor T1.

In this embodiment, the working principle of the third transistor T3 is the same as in the above embodiments, and will not be repeated here.

In some embodiments, the specific models and capacitance values of the fourth capacitor C4, the fifth capacitor C5, and the sixth capacitor C6 can be set by those skilled in the art according to the actual situation, and no further restrictions are imposed here.

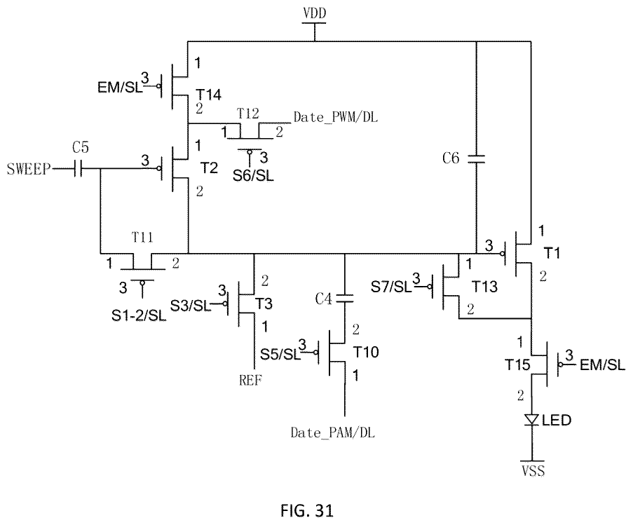

The overall working principle of the pixel circuit described above will be explained below with reference to some embodiments. As shown in FIG. 31, the pixel circuit can include a first transistor T1, a second transistor T2, a third transistor T3, a tenth transistor T10, an eleventh transistor T11, a twelfth transistor T12, a thirteenth transistor T13, a fourteenth transistor T14, a fifteenth transistor T15, a fourth capacitor C4, a fifth capacitor C5, and a sixth capacitor C6. The transistors and capacitors in embodiments shown in FIG. 31 operate on the same principle as those in the embodiments described above, and the signals provided by the data lines and scan lines are also the same, so they will not be described again here. In some embodiments, due to the presence of the third transistor T3, the first transistor T1 and the second transistor T2 can be reset by the third transistor T3, which directly reduces the number of devices in the display apparatus, saves the area occupied by the pixel circuit in the display panel, and effectively improves the pixel density and the resolution of the display panel. Furthermore, the pixel circuit shown in embodiments of FIG. 31 does not exhibit transistor charging phenomenon, thus reducing the driving power consumption of the pixel circuit. It should be noted that embodiments shown in FIG. 31 is only an example and does not limit all transistors in the pixel circuit to P-type transistors, which will not be elaborated further here.

According to some embodiments of the present application, the pixel circuit can be any of the pixel circuits in the above embodiments and in FIGS. 23 to 31 of embodiments. The driving phase of the pixel circuit can include, in sequence, a first reset phase, a first compensation phase, a second data writing phase, a second reset phase, a second compensation phase, a second data writing phase, and a light-emitting phase. For the pixel circuit shown in embodiments of FIG. 23, the driving phases include the following phases.

The principles of the first reset phase and second reset phase are the same as those described above for the principle in FIG. 10, as detailed above, and will not be repeated here.

In the second data writing phase, the third data writing control signal S5 is at the active potential, the tenth transistor T10 is turned on, and the third data signal Date_PAM is provided to the gate electrode of the first transistor T1.

In the light-emitting phase, the gate electrode of the first transistor T1 receives an active potential and is turned on. The power signal VDD received by the first electrode of the first transistor T1 and the third data signal Date_PAM received by the gate of the first transistor T1 are configured to provide a driving signal to the light-emitting element LED through the second electrode of the first transistor T1. The gate electrode of the second transistor T2 receives an active potential and is turned on. The power signal VDD received by the first electrode of the second transistor T2 is configured to provide a control signal to the gate electrode of the first transistor T1 through the second electrode of the second transistor T2 to control the light emission duration of the light-emitting element LED. In some embodiments, after the first transistor T1 is turned on, the first transistor T1 can provide driving signals of different amplitudes to the light-emitting element LED according to the third data signal Date_PAM, ensuring that the light-emitting element LED emits light of a fixed wavelength, thus realizing the PAM driving mode. The second transistor T2 can control the turned-on and turn-off of the first transistor T1 by applying a light emission duration control signal to the gate electrode of the first transistor T1, thereby controlling the time when the first transistor T1 provides a driving signal to the light-emitting element LED, thus realizing the PWM driving mode.

In some embodiments, as shown in FIG. 25, in the first reset phase, the second compensation and reset control signal S1-2 and the reset control signal S3 are at active potentials. The third transistor T3 is turned on and provides the reset signal REF to the second electrode of the eleventh transistor T11. The eleventh transistor T11 is turned on and provides the reset signal REF to the gate electrode of the second transistor T2. The second transistor T2 is reset and turned on using the reset signal REF received at the gate electrode of the second transistor T2.

In the first compensation phase and the second data writing phase, the second compensation and reset control signal S1-2 and the fourth data writing control signal S6 are at active potentials. The eleventh transistor T11 is turned on and provides threshold compensation for the second transistor T2. At the same time, the twelfth transistor T12 is turned on, and the fourth data signal Date_PWM is written to the gate electrode of the second transistor T2 through the turned-on twelfth transistor T12, the turned-on second transistor T2, and the turned-on eleventh transistor T11 in sequence. Since the fourth data signal Date_PWM is written to the first electrode of the second transistor T2, and the threshold compensation is performed on the gate electrode of the second transistor T2, data writing and threshold compensation can be performed simultaneously for the second transistor T2.

In this embodiment, the principles of the other driving phases are the same as in the above embodiments, and will not be repeated here.

In some embodiments, as shown in FIG. 26, in the second compensation phase, the third compensation control signal S7 is at an active potential, the thirteenth transistor T13 is turned on, and the potential at the second electrode of the first transistor T1 is compensated to the potential at the gate of the first transistor T1, thereby completing the threshold compensation of the first transistor T1. In some embodiments, since the third data signal Date_PAM is written to the gate electrode of the first transistor T1, threshold compensation cannot be performed on the first transistor T1 at the same time as the third data signal Date_PAM is written, otherwise the threshold compensation of the gate electrode of the first transistor T1 can be affected by the interference of the third data signal Date_PAM.

In this embodiment, the principles of the other driving phases are the same as in the above embodiments, and will not be repeated here.

In some embodiments, as shown in FIG. 27, during the light-emitting phase, the third driving control signal EM and the fourth driving control signal EM are at an active potential, and the fourteenth transistor T14 and the fifteenth transistor T15 are turned on. The driving signal provided by the first transistor T1 can drive the light-emitting element LED to emit light through the fifteenth transistor T15. At the same time, the power supply signal VDD reaches the first electrode of the second transistor T2 through the turned-on fourteenth transistor T14. When the second transistor T2 controls the light emission duration of the light-emitting element LED, the second transistor T2 can be turned on, allowing the power supply signal to reach the gate electrode of the first transistor T1 through the second transistor T2, causing the first transistor T1 to turn off.

In some embodiments, as shown in FIG. 28, during the light-emitting phase, the light emission duration control signal transitions from an inactive potential to an active potential. The active potential of the light emission duration control signal enables the second transistor T2 to turn on. Since the first electrode of the second transistor T2 can receive the power supply signal VDD during the light-emitting phase, when the second transistor T2 is turned on, the power supply signal VDD at the inactive potential can reach the gate electrode of the first transistor T1 through the second transistor T2, causing the first transistor T1 to turn off and the light-emitting element LED to stop emitting light.

In this embodiment, the principles of the other driving phases are the same as in the above embodiments, and will not be repeated here.

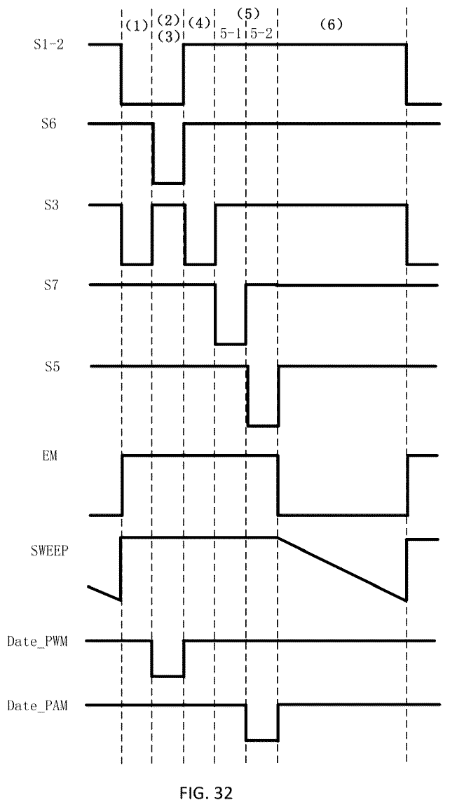

Embodiments of the driving method for each phase of the pixel circuit shown in FIG. 31 will be described below. The timing diagram of each signal in the circuit corresponding to embodiments of FIG. 31 is shown in FIG. 32. The driving phases of the pixel circuit shown in embodiments of FIG. 31 can include the first reset phase (1), the first compensation phase (2), the first data writing phase (3), the second reset phase (4), the second compensation phase and the second data writing phase (5), and the light-emitting phase (6). In the pixel circuit shown in embodiments of FIG. 31, each transistor can be a P-type transistor, and each transistor can be turned on in response to the low potential, so the active potential is the low potential.

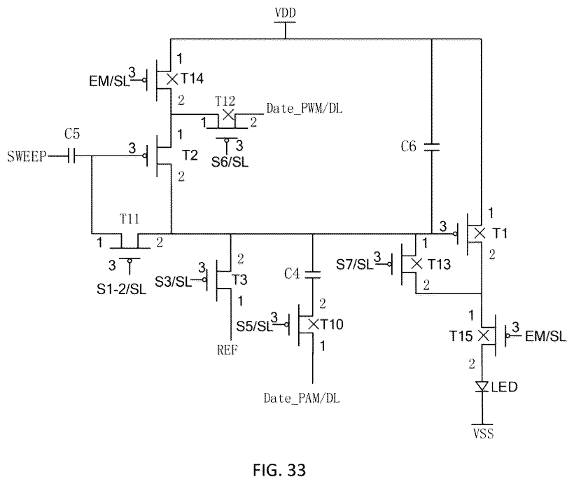

In the first reset phase, corresponding to phase (1) in FIG. 32, the reset control signal S3, the second compensation and reset control signal S1-2 are at the low potential, and other signals remain the high potential, as shown in FIG. 33 (in FIG. 33, transistors marked with “x” are in the turned-off state, which does not mean that the transistor does not exist, and unmarked transistors are in the turned-on state. The same applies to the figures of other embodiments, and will not be repeated). Since the reset control signal S3, the second compensation and reset control signal S1-2 are at the low potential, the eleventh transistor T11 and the third transistor T3 are turned on, and other transistors are turned off. Since the eleventh transistor T11 and the third transistor T3 are turned on, and other transistors are in the turned-off state, the reset signal REF can first pass through the third transistor T3, and then through the eleventh transistor T11 to charge the fifth capacitor C5, so that the node of the gate electrode of the second transistor T2 is reset to the REF potential. At the same time, since the REF potential is the low potential for the embodiment shown in FIG. 31, the second transistor T2 is turned on in response to the REF potential (low potential) of the gate electrode of the second transistor T2.

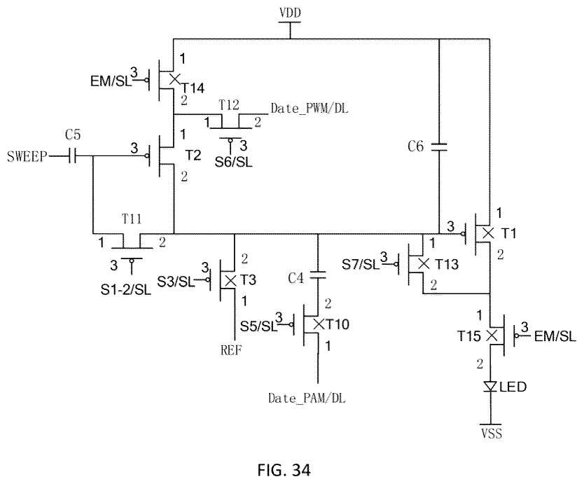

In the first compensation phase and the first data writing phase, corresponding to phases (2) and (3) in FIG. 32, the fourth data writing control signal S6 and the second compensation and reset control signal S1-2 are at the low potential, while other signals remain at the high potential. As shown in FIG. 34, since the fourth data writing control signal S6 and the second compensation and reset control signal S1-2 are at the low potential, the eleventh transistor T11 and the twelfth transistor T12 are turned on, while other transistors are turned off. Since the second transistor T2 is in the turned-on state at this time, the fourth data signal Date_PWM can reach the second electrode of the second transistor T2. The eleventh transistor T11 writes the fourth data signal Date_PWM into the node at the gate electrode of the second transistor T2 while performing threshold compensation on the second transistor T2. At this time, the potential at the gate electrode of the second transistor T2 is VA=V(Date_PWM)+Vth, and the second transistor T2 is turned off.

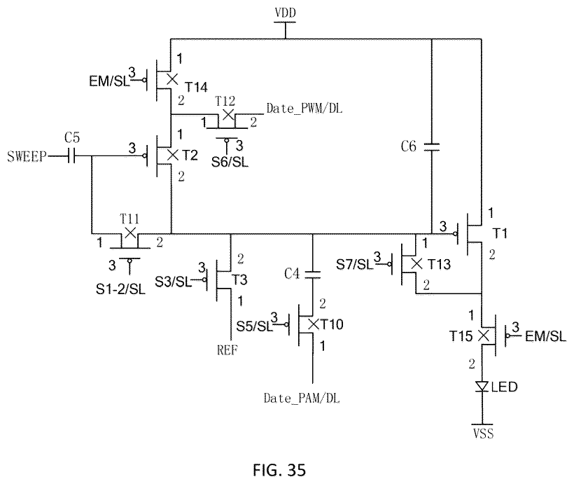

In the second reset phase, corresponding to phase (4) in FIG. 32, the reset control signal S3 is at the low potential, while other signals remain the high potential. As shown in FIG. 35, since the reset control signal S3 is at the low potential, the third transistor T3 is turned on, and the other transistors are turned off. Since the third transistor T3 is turned on, the reset signal REF can charge the sixth capacitor C6 through the third transistor T3, so that the node at the gate electrode of the first transistor T1 is reset to the REF potential, and the first transistor T1 is turned on. It should be noted that although the third transistor T3 is turned on during the first reset phase, after the first compensation phase and the first data writing phase, the fourth data signal Date_PWM reaches the gate electrode of the first transistor T1 through the turned-on second transistor T2, so that the potential at the gate electrode of the first transistor T1 is no longer the REF potential. Therefore, the gate electrode of the first transistor T1 needs to be reset again during the second reset phase.

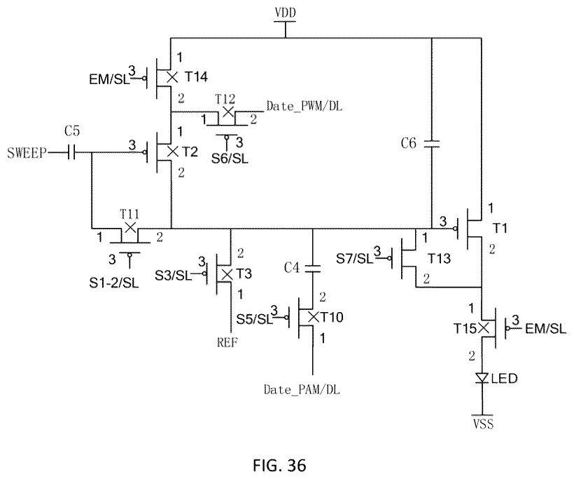

In the second compensation phase, corresponding to phase (5-1) in FIG. 32, the third compensation control signal S7 is at the low potential, while other signals remain the high potential. As shown in FIG. 36, since the third compensation control signal S7 is at the low potential, the thirteenth transistor T13 is turned on, and the other transistors are turned off. Since the thirteenth transistor T13 and the first transistor T1 are turned on, the power supply signal VDD can reach the second electrode of the first transistor T1 through the first transistor T1. The thirteenth transistor T13 can provide the signal at the second electrode of the first transistor T1 to the gate electrode of the first transistor T1, realizing the threshold compensation of the first transistor T1. At this time, the potential at the gate of the first transistor T1 is VB=VDD+Vth.

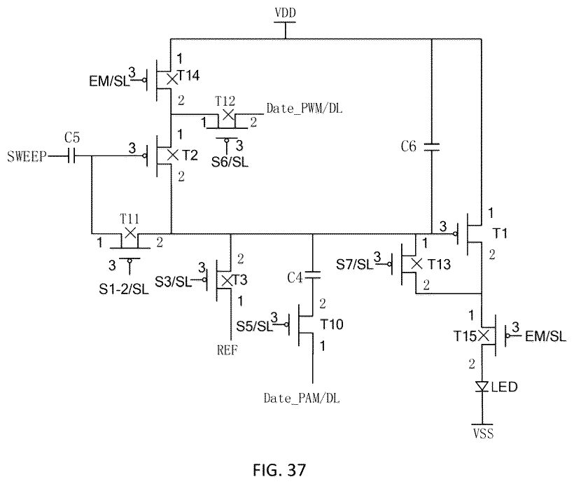

In the second data writing phase, corresponding to phase (5-2) in FIG. 32, the third data writing control signal S5 is at the low potential, while other signals remain the high potential. As shown in FIG. 37, since the third data writing control signal S5 is at the low potential, the tenth transistor T10 is turned on. The third data signal Date_PAM can be coupled to the gate electrode of the first transistor T1 through the tenth transistor T10 and the fourth capacitor C4. At this time, the potential at the gate of the first transistor T1 is VB=V(Date_PAM)+VDD+Vth.

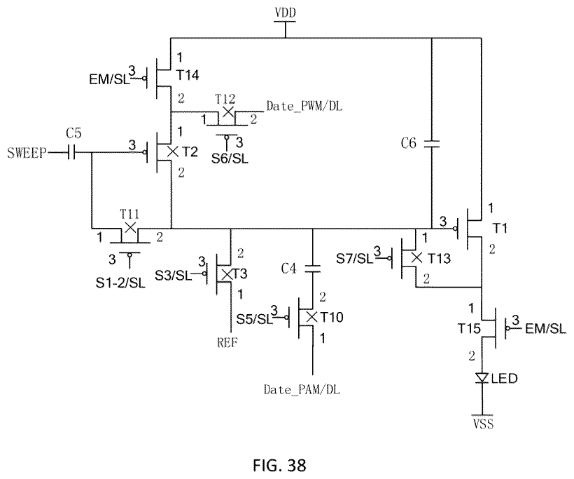

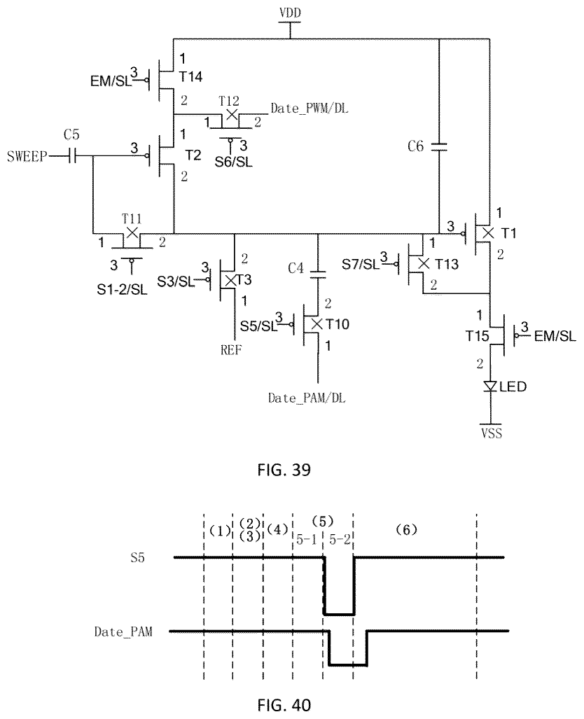

In the light-emitting phase, corresponding to phase (6) in FIG. 32, the third driving control signal EM and the fourth driving control signal EM are at the low potential, the light emission duration control signal SWEEP gradually decreases from the high potential, and other signals remain the high potential. As shown in FIG. 38, since the third driving control signal EM and the fourth driving control signal EM are at the low potential, the fourteenth transistor T14 and the fifteenth transistor T15 are turned on. At the same time, since the first transistor T1 was turned on in the previous phase, the power supply signal VDD drives the light-emitting element LED to start emitting light through the first transistor T1 and the fifteenth transistor T15. As the potential of the light emission duration control signal SWEEP decreases, coupled with the coupling effect of fifth capacitor C5, the potential VA at the gate electrode of the second transistor T2 gradually decreases from V(Date_PWM)+Vth until the second transistor T2 is in the turned-on state, as shown in FIG. 39. After the second transistor T2 is turned on, and the fourteenth transistor T14 is turned on, the high-potential VDD signal can charge the sixth capacitor C6 through the fourteenth transistor T14 and the second transistor T2. At the same time, the node potential at the gate electrode of the first transistor T1 gradually increases until the first transistor T1 is turned off, as shown in FIG. 39. At this time, the light-emitting element LED stops emitting light.

In some embodiments, as shown in FIG. 40, in the second data writing phase, the starting time of the active potential of the third data signal Date_PAM lags behind the starting time of the active potential of the third data writing control signal S5 by a first preset time; in the light-emitting phase, the ending time of the active potential of the third data signal Date_PAM lags behind the ending time of the active potential of the third data writing control signal S5 by a second preset time. Both the first preset time and the second preset time are less than the duration of the active potential of the third data writing control signal S5. Based on this, the first preset time and the second preset time are such that the active potential of the third data signal Date_PAM is slightly delayed compared to the active potential of the third data writing control signal S5. The specific values are not limited.

In some embodiments, if the third data signal Date_PAM stops writing at the same time that the tenth transistor T10 is turned off, then the fourth capacitor C4 can couple part of the third data signal Date_PAM, preventing the third data signal Date_PAM from being completely written to the first transistor T1. Therefore, in some embodiments, as shown in the timing diagram of FIG. 40, the overall timing of the third data signal Date_PAM needs to lag slightly behind the third data writing control signal S5. That is, the falling edge of the high potential of the third data signal Date_PAM needs to lag slightly behind the falling edge of the high potential of the third data writing control signal S5, and at the same time, the rising edge of the low potential of the third data signal Date_PAM needs to lag slightly behind the rising edge of the low potential of the third data writing control signal S5.

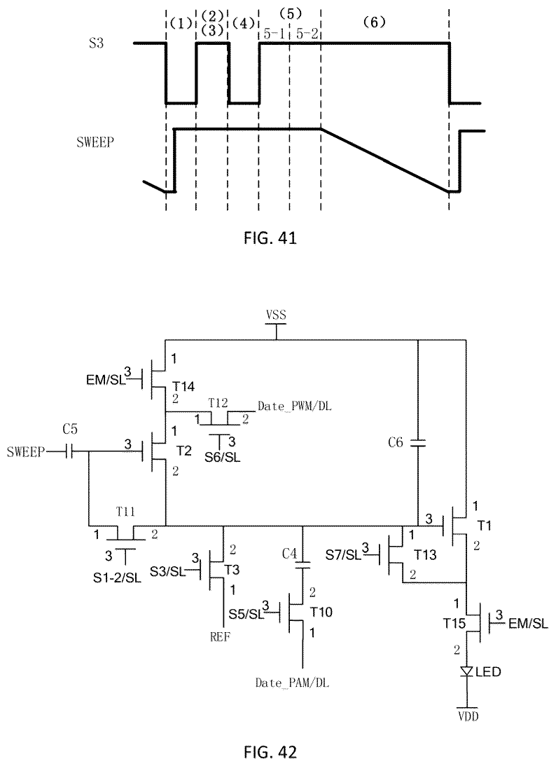

In some embodiments, as shown in FIG. 41, in the first reset phase, the starting time of the inactive potential of the light emission duration control signal SWEEP is delayed by a third preset time compared to the starting time of the active potential of the reset control signal S3. The third preset time is less than the duration of the active potential of the reset control signal S3 in the first reset phase. Based on this, the third preset time can be such that the starting time of the inactive potential of the light emission duration control signal SWEEP is slightly delayed after the active potential of the reset control signal S3 in the first reset phase. The specific value is not limited.

In some embodiments, in order to ensure that the first transistor T1 is always turned off when the light-emitting element LED needs to stop emitting light, the rising edge of the light emission duration control signal SWEEP after the end of the light-emitting phase (6) can be slightly delayed from the end of the light-emitting phase (6), as shown in FIG. 41. That is, the rising edge of the low potential of the light emission duration control signal SWEEP in the first reset phase (1) of the next frame is slightly delayed from the falling edge of the high potential of the reset control signal S3. Meanwhile, since the circuit is still in the first reset phase (1) after the light emission duration control signal SWEEP returns to the high potential, the voltage jump of the light emission duration control signal SWEEP on the gate electrode of the second transistor T2 can be repaired by the reset signal REF, and will not affect the normal operation of the circuit.

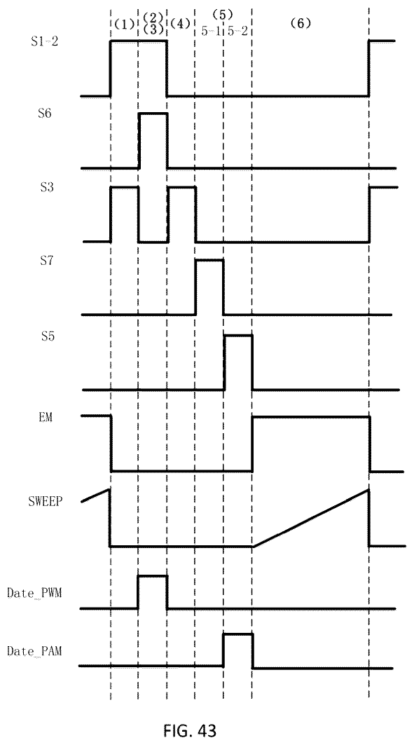

In some embodiments, as shown in the pixel circuit of FIG. 42, each transistor can be an N-type transistor, and each transistor can be turned on in response to a high potential at the gate electrode of each transistor, that is, the active potential is a high potential. The timing diagram of each signal in the circuit corresponding to embodiments of FIG. 42 is shown in FIG. 43.

In the first reset phase, corresponding to phase (1) in FIG. 43, the reset control signal S3 and the second compensation and reset control signal S1-2 are at the high potential, while other signals remain the low potential. Since the reset control signal S3 and the second compensation and reset control signal S1-2 are at the high potential, the eleventh transistor T11 and the third transistor T3 are turned on, while other transistors are turned off. Since the eleventh transistor T11 and the third transistor T3 are turned on, while other transistors are in the turned-off state, the reset signal REF can first pass through the third transistor T3 and then through the eleventh transistor T11 to charge the fifth capacitor C5, thereby resetting the node at the gate electrode of the second transistor T2 to the REF potential. At the same time, since the REF potential is high potential for the embodiment shown in FIG. 31, the second transistor T2 is turned on in response to the REF potential (high potential) of the gate electrode the second transistor T2.

In the first compensation phase and the first data writing phase, corresponding to phases (2) and (3) in FIG. 43, the fourth data writing control signal S6 and the second compensation and reset control signal S1-2 are at the high potential, while other signals remain at the low potential. Since the fourth data writing control signal S6 and the second compensation and reset control signal S1-2 are at the high potential, the eleventh transistor T11 and the twelfth transistor T12 are turned on, while other transistors are turned off. Since the second transistor T2 is in the turned-on state at this time, the fourth data signal Date_PWM can reach the second electrode of the second transistor T2. The eleventh transistor T11 can write the fourth data signal Date_PWM into the node at the gate electrode of the second transistor T2 while performing threshold compensation on the second transistor T2. At this time, the potential at the gate electrode of the second transistor T2 is VA=V(Date_PWM)+Vth, and the second transistor T2 is turned off.

In the second reset phase, corresponding to phase (4) in FIG. 43, the reset control signal S3 is at the high potential, and other signals remain the low potential. Since the reset control signal S3 is at the high potential, the third transistor T3 is turned on, and other transistors are turned off. Since the third transistor T3 is turned on, the reset signal REF can charge the sixth capacitor C6 through the third transistor T3, so that the node at the gate electrode of the first transistor T1 is reset to the REF potential, and the first transistor T1 is turned on. It should be noted that although the third transistor T3 is turned on during the first reset phase, after the first compensation phase and the first data writing phase, the fourth data signal Date_PWM reaches the node at the gate electrode of the first transistor T1 through the turned-on second transistor T2, so that the potential at the gate electrode of the first transistor T1 is no longer the REF potential. Therefore, the gate electrode of the first transistor T1 needs to be reset again during the second reset phase.

In the second compensation phase, corresponding to phase (5-1) in FIG. 43, the third compensation control signal S7 is at the high potential, while other signals remain the low potential. Since the third compensation control signal S7 is at the high potential, the thirteenth transistor T13 is turned on, and the other transistors are turned off. Since the thirteenth transistor T13 and the first transistor T1 are turned on, the power supply signal VSS can reach the second electrode of the first transistor T1 through the first transistor T1. The thirteenth transistor T13 can provide the signal of the second electrode of the first transistor T1 to the gate electrode of the thirteenth transistor T13, realizing the threshold compensation of the first transistor T1. At this time, the potential at the gate electrode of the first transistor T1 is VB=VSS+Vth.

In the second data writing phase, corresponding to phase (5-2) in FIG. 43, the third data writing control signal S5 is at the high potential, while other signals remain the low potential. Since the third data writing control signal S5 is at the high potential, the tenth transistor T10 is turned on. The third data signal Date_PAM can be coupled to the gate electrode of the first transistor T1 through the tenth transistor T10 and the fourth capacitor C4. At this time, the potential at the gate electrode of the first transistor T1 is VB=V(Date_PAM)+VSS+Vth.

In the light-emitting phase, corresponding to phase (6) in FIG. 43, the third driving control signal EM and the fourth driving control signal EM is at the high potential, the light emission duration control signal SWEEP gradually increases from the low potential, and other signals remain the low potential. Since the third driving control signal EM and the fourth driving control signal EM is at the high potential, the fourteenth transistor T14 and the fifteenth transistor T15 are turned on. At the same time, since the first transistor T1 was turned on in the previous phase, the power supply signal VSS can drive the light-emitting element LED to start emitting light through the first transistor T1 and the fifteenth transistor T15. As the potential of the light emission duration control signal SWEEP increases, coupled with the coupling effect of the fifth capacitor C5, the potential VA at the gate electrode of the second transistor T2 gradually increases from V(Date_PWM)+Vth until the second transistor T2 is in the turned-on state. After the second transistor T2 is turned on, and the fourteenth transistor T14 is turned on, the low-potential VSS signal can charge the sixth capacitor C6 through the fourteenth transistor T14 and the second transistor T2. At the same time, the potential of the node at the gate electrode of the first transistor T1 gradually decreases until the first transistor T1 is turned off, at which point the light-emitting element LED stops emitting light.

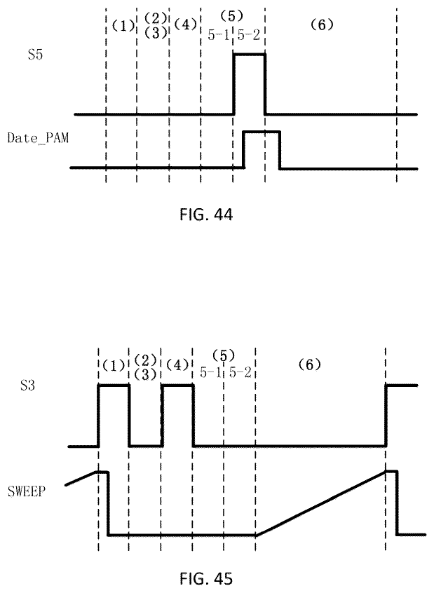

In some embodiments, if the third data signal Date_PAM stops writing at the same time that the tenth transistor T10 is turned off, then the fourth capacitor C4 can couple part of the third data signal Date_PAM, preventing the third data signal Date_PAM from being completely written to the first transistor T1. Therefore, in some embodiments, as shown in the timing diagram of FIG. 44, the overall timing of the third data signal Date_PAM needs to lag slightly behind the third data writing control signal S5. That is, the rising edge of the low potential of the third data signal Date_PAM needs to lag slightly behind the rising edge of the low potential of the third data writing control signal S5, and at the same time, the falling edge of the high potential of the third data signal Date_PAM needs to lag slightly behind the falling edge of the high potential of the third data writing control signal S5.

In some embodiments, in order to ensure that the first transistor T1 is always turned off when the light-emitting element LED needs to stop emitting light, the falling edge of the light emission duration control signal SWEEP after the end of the light-emitting phase (6) can be slightly delayed from the end of the light-emitting phase (6), as shown in FIG. 45. That is, the falling edge of the high potential of the light emission duration control signal SWEEP in the first reset phase (1) of the next frame is slightly delayed from the rising edge of the low potential of the reset control signal S3. Meanwhile, since the circuit is still in the first reset phase (1) after the light emission duration control signal SWEEP returns to the low potential, the voltage jump of the light emission duration control signal SWEEP on the gate electrode of the second transistor T2 can be repaired by the reset signal REF and cannot affect the normal operation of the circuit.

It should be noted that the above embodiments of the present application respectively provide embodiments in which all the pixel circuits are N-type transistors and embodiments in which all the pixel circuits are P-type transistors. For embodiments in which some of the pixel circuits are N-type transistors and some are P-type transistors, those skilled in the art can derive the corresponding driving methods and driving timing based on the description of the above embodiments and FIGS. 10 to 22 and FIGS. 31 to 45, all of which are within the protection scope of the present application.

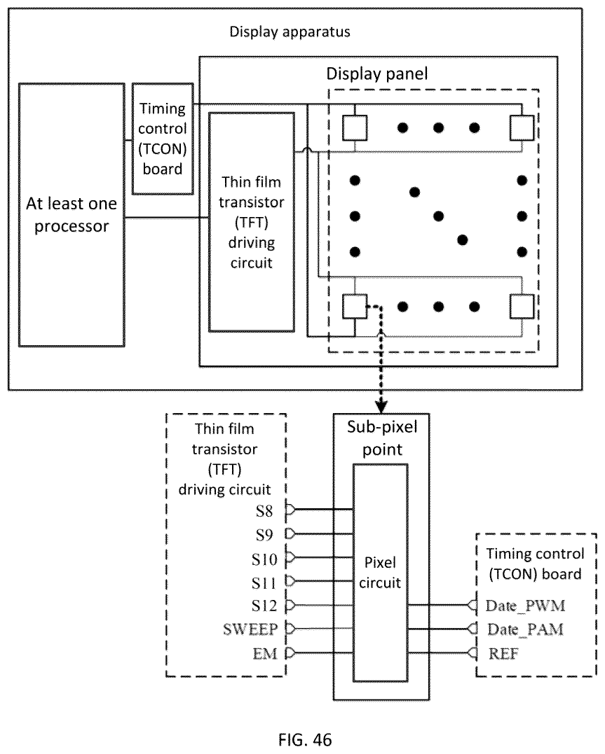

FIG. 46 is another schematic diagram of a display apparatus according to some embodiments of the present application. As shown in FIG. 46, the display apparatus is driven by a combination of PWM driving and PAM driving. In some embodiments, the display apparatus can include at least one processor, a timing controller (TCON) board and a display panel. The display panel can include a pixel matrix (i.e., the pixel array unit) composed of the plurality of sub-pixels and a thin film transistor (TFT) driving circuits. The dashed box in the display panel in FIG. 46 represents the pixel matrix. Each sub-pixel in the pixel matrix can include a pixel circuit, and each pixel circuit is connected to the TFT driving circuit and the TCON board respectively. At least one processor is connected to both the TFT driving circuit and the TCON board. It should be noted that the TFT driving circuit can be arranged on the top and bottom sides of the display panel, or arranged on the left and right sides of the display panel, or on any side of the display panel. Embodiments of the present application do not limit the position of the TFT driving circuit in the display panel.

In some embodiments, after at least one processor obtains image data, the at least one processor outputs control signals to the pixel circuit through the first control signal output terminal S8, the second control signal output terminal SWEEP, the third control signal output terminal S9, the fourth control signal output terminal S10, the fifth control signal output terminal S11, the sixth control signal output terminal S12, and the switch signal output terminal EM in the TFT driving circuit. Control signals and reset signals are output to the pixel circuit through the pulse width modulation (PWM) driving signal output terminal Date_PWM, the pulse amplitude modulation (PAM) driving signal output terminal Date_PAM, and the reset signal output terminal REF in the TCON board. The pixel circuit controls the illumination and extinguishing of the micro LEDs based on control signals and reset signals. Based on this, the pixel circuit driving method adopts a combination of PWM driving and PAM driving. The control signal output from the PWM driving signal output terminal Date_PWM can control the light emission duration of the micro LED, thereby controlling the brightness perceived by the human eye. The control signal output from the PAM driving signal output terminal Date_PAM can control the light emission wavelength of the micro LED. However, the TFTs in the pixel circuit that implement PWM driving and PAM driving are prone to threshold voltage drift after long-term use, which causes changes in the light emission duration and wavelength of the micro LEDs, resulting in poor display effect.

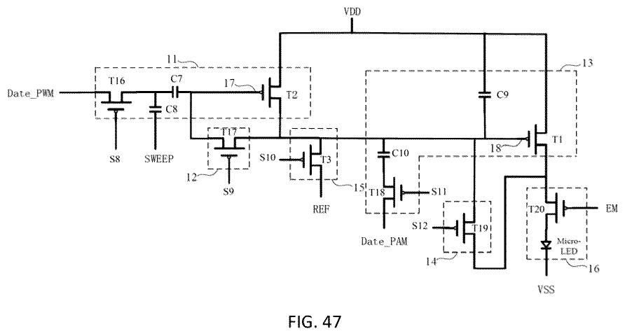

FIG. 47 is another schematic diagram of a pixel circuit according to some embodiments of the present application. As shown in FIG. 47, the pixel circuit can include a PWM driving circuit 11, a first compensation circuit 12, a PAM driving circuit 13, a second compensation circuit 14, a reset circuit 15, and a light-emitting circuit 16. By adding a compensation circuit to the pixel circuit, a compensation voltage is applied to the gate electrode (also known as the control terminal) of the TFT in the PWM driving circuit and the PAM driving circuit. Based on the compensation voltage, by applying an additional voltage, the TFT can be switched on and off without being affected by threshold voltage drift. This makes the current flowing through the light-emitting element, such as the micro LED, more stable, and the light emission duration and wavelength do not change, thus improving the display effect.

The circuit structure of the pixel circuit described above in some embodiments of the present application will be described below. As shown in FIG. 47, the PWM driving circuit 11 can include a sixteenth transistor T16 (also known as the first switching circuit), a seventh capacitor C7, an eighth capacitor C8, and a second transistor T2 (also known as the second switching circuit, the same below, and will not be described again). It should be noted that FIG. 47 illustrates the case where each of the switching circuits included in the pixel circuit can be a P-type TFT. In some cases, at least one of the switching circuits included in the pixel circuit can be an N-type TFT.

The first electrode of the sixteenth transistor T16 is connected to the PWM driving signal output terminal Date_PWM, and the second electrode of the sixteenth transistor T16 is connected to the first electrode of the seventh capacitor C7 and the first electrode of the eighth capacitor C8 respectively. The gate electrode of the sixteenth transistor T16 is connected to the first control signal output terminal S8, the second electrode of the eighth capacitor C8 is connected to the second control signal output terminal SWEEP, the second electrode of the seventh capacitor C7 is connected to the gate electrode of the second transistor T2 (denoted as control terminal 17), the first electrode of the second transistor T2 is connected to the first power supply terminal, which is the reference power supply output terminal VDD; the control terminal 17 of the second transistor T2 is the control terminal 17 of the PWM driving circuit 11. The sixteenth transistor T16 is controlled by the control signal output from the first control signal output terminal S8, that is, the S8 signal. When the S8 signal is at the first potential, the sixteenth transistor T16 is in the turned-on state; when the S8 signal is at the second potential, the sixteenth transistor T16 is in the turned-off state. It should be noted that when the switching circuit is a P-type TFT, the first potential is a low potential and the second potential is a high potential. The sixteenth transistor T16 can be configured to set the voltage at the control terminal 17 of the second transistor T2 to the first driving voltage, thereby enabling the driving voltage to be written. The second transistor T2 is controlled by the voltage at its control terminal. When the switching circuit is a P-type TFT, the second transistor T2 is in the turned-on state when the voltage at the control terminal is less than the first compensation voltage; the second transistor T2 is in the turned-off state when the voltage at the control terminal is greater than or equal to the first compensation voltage. The second transistor T2 can be configured to control the turned-off state of the first transistor T1.

The reset circuit 15 is connected to the control terminal of the second transistor T2 through the first compensation circuit 12, and the second electrode of the second transistor T2 is connected to the first compensation circuit 12.

The control terminal 18 of the PAM driving circuit 13 is connected to the reset circuit 15, the second compensation circuit 14, and the second electrode of the second transistor T2, respectively. The light-emitting circuit 16 is connected to the PAM driving circuit 13.

The first compensation circuit 12 can include a seventeenth transistor T17, and the reset circuit 15 can include a third transistor T3. The first electrode of the seventeenth transistor T17 is connected to the gate electrode of the second transistor T2, the second electrode of the seventeenth transistor T17 is connected to the second electrode of the second transistor T2, and the gate electrode of the seventeenth transistor T17 is connected to the third control signal output terminal S9. The gate electrode of the third transistor T3 is connected to the fourth control signal output terminal S10, the first electrode of the third transistor T3 is connected to the second electrode of the seventeenth transistor T17, and the second electrode of the third transistor T3 is connected to the reset signal output terminal REF.

The seventeenth transistor T17 is controlled by the control signal output from the third control signal output terminal S9, that is, the S9 signal. When the S9 signal is at the first potential, the seventeenth transistor T17 is in the turned-on state; when the S9 signal is at the second potential, the seventeenth transistor T17 is in the turned-off state. The seventeenth transistor T17 can be configured to set the voltage at the control terminal 17 of the second transistor T2 to the first compensation voltage, thereby achieving threshold voltage compensation. The third transistor T3 is controlled by the control signal output from the fourth control signal output terminal S10, that is, the S10 signal. When the S10 signal is at the first potential, the third transistor T3 is in the turned-on state; when the S10 signal is at the second potential, the third transistor T3 is in the turned-off state. The third transistor T3 can be configured to set the voltage at the control terminal 17 of the second transistor T2 and the control terminal 18 of the first transistor T1 to the reset voltage.

The PAM driving circuit 13 can include an eighteenth transistor T18, a ninth capacitor C9, a tenth capacitor C10, and a first transistor T1. The first electrode of the eighteenth transistor T18 is connected to the first electrode of the tenth capacitor C10, the second electrode of the eighteenth transistor T18 is connected to the PAM driving signal output terminal Date_PAM, and the gate electrode of the eighteenth transistor T18 is connected to the fifth control signal output terminal S11. The second electrode of the tenth capacitor C10 is connected to the first electrode of the ninth capacitor C9 and the control terminal 18 of the first transistor T1. The first power supply terminal is the reference power supply output terminal VDD, which is connected to the second electrode of the ninth capacitor C9 and the first electrode of the first transistor T1. The control terminal 18 of the first transistor T1 is the control terminal 18 of the PAM driving circuit 13. The first electrode of the third transistor T3 is connected to the control terminal 18 of the first transistor T1.

The eighteenth transistor T18 can be controlled by the control signal output from the fifth control signal output terminal S11, that is, the S11 signal. When the S11 signal is at the first potential, the eighteenth transistor T18 is in the turned-on state; when the S11 signal is at the second potential, the eighteenth transistor T18 is in the turned-off state. The eighteenth transistor T18 can be configured to set the voltage at the control terminal 18 of the first transistor T1 to the second driving voltage, thereby enabling the driving voltage to be written. The first transistor T1 is controlled by the voltage at the control terminal of the first transistor T1. When the switching circuit is a P-type TFT, the first transistor T1 is in the turned-on state when the voltage at the control terminal of the first transistor T1 is less than the second compensation voltage; the first transistor T1 is in the turned-off state when the voltage at the control terminal of the first transistor T1 is greater than or equal to the second compensation voltage. The first transistor T1 can be configured to control the light-emitting element to light up and turn off. In some embodiments, the light-emitting element can be a micro-LED.

The second compensation circuit 14 can include a nineteenth transistor T19. The first electrode of the nineteenth transistor T19 is connected to the control terminal 18 of the first transistor T1, the second electrode of the nineteenth transistor T19 is connected to the second electrode of the first transistor T1, and the gate electrode of the nineteenth transistor T19 is connected to the sixth control signal output terminal S12. The nineteenth transistor T19 is controlled by the control signal output from the sixth control signal output terminal S12, that is, the S12 signal. When the S12 signal is at the first potential, the nineteenth transistor T19 is in the turned-on state; when the S12 signal is at the second potential, the nineteenth transistor T19 is in the turned-off state. The nineteenth transistor T19 can be configured to set the voltage at the control terminal 18 of the first transistor T1 to the second compensation voltage to achieve threshold voltage compensation.

The light-emitting circuit 16 can include a twentieth transistor T20 and a light-emitting element. In some embodiments, the light-emitting element can be a micro-LED. The gate electrode of the twentieth transistor T20 is connected to the switch signal output electrode EM, the first electrode of the twentieth transistor T20 is connected to the second electrode of the first transistor T1, the second electrode of the twentieth transistor T20 is connected to the first electrode of the light-emitting element, and the second electrode of the light-emitting element is connected to the second power supply terminal. The first electrode is the positive electrode, the second electrode is the negative electrode, and the second power supply terminal is the ground electrode VSS. The second electrode of the second transistor T2 is connected to the control terminal 18 of the first transistor T1. The twentieth transistor T20 can be controlled by the control signal output from the switch signal output electrode EM, that is, the EM signal. When the EM signal is at the first potential, the twentieth transistor T20 is in the turned-on state; when the EM signal is at the second potential, the twentieth transistor T20 is in the turned-off state. The twentieth transistor T20 can be configured to control the illumination and extinguishing of the light-emitting element.

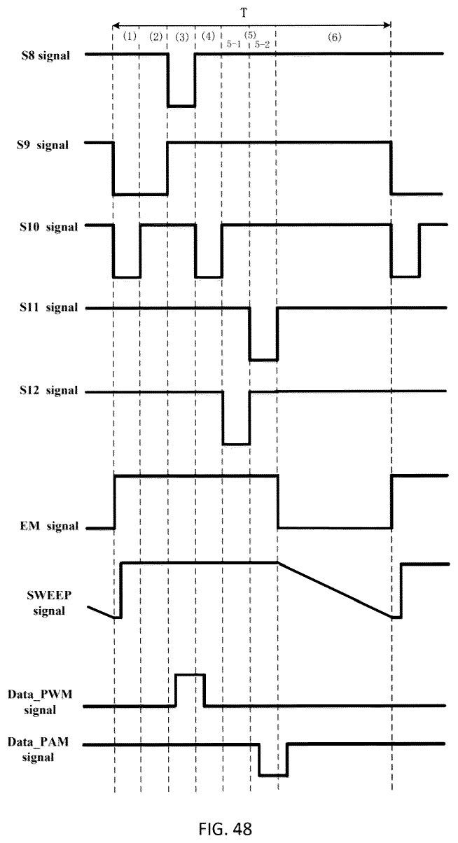

FIG. 48 is a timing diagram of control signals according to some embodiments of the present application. This timing diagram of control signals can be configured to control the pixel circuit shown in FIG. 47. The operation of the pixel circuit will be explained below.

As shown in FIG. 48, a display cycle T can include a first reset phase (1), a first compensation phase (2), a first data writing phase (also known as the first driving voltage writing phase) (3), a second reset phase (4), a second compensation phase and a second data writing phase (also known as the second driving voltage writing phase) (5), and a light-emitting phase (6) arranged in order from early to late. The control signal output from the second control signal output terminal SWEEP is the SWEEP signal, the control signal output from the PWM driving signal output terminal Date_PWM is the Date_PWM signal, and the control signal output from the PAM driving signal output terminal Date_PAM is the Date_PAM signal.

In the first reset phase, corresponding to phase (1) in FIG. 48, S9 signal, S10 signal, and Date_PWM signal are low-potential signals, while S8 signal, S11 signal, S12 signal, EM signal, and Date_PAM signal are high-potential signals. The SWEEP signal remains low for a preset duration before turning high. Based on FIG. 47, FIG. 49 is a schematic diagram of the pixel circuit during the first reset phase according to some embodiments of the present application. As shown in FIG. 49, transistors marked with “x” are in the turned-off state, which does not mean that the transistor does not exist, and unmarked transistors are in the turned-on state. Since S9 signal and S10 signal are low-potential signals, the seventeenth transistor T17 and the third transistor T3 are turned on; S8 signal, S11 signal, S12 signal, and EM signal are high-potential signals, so the sixteenth transistor T16, the eighteenth transistor T18, the nineteenth transistor T19, and the twentieth transistor T20 are turned off. The reset signal output terminal REF outputs a reset signal with a reset voltage. The reset signal can pass through the third transistor T3 and the seventeenth transistor T17 in sequence, and reach the control terminal 17 of the second transistor T2 and the second electrode of the seventh capacitor C7, so that the voltage of the control terminal 17 of the second transistor T2 is the reset voltage and the seventh capacitor C7 is charged. Since the reset voltage is at the low potential, the second transistor T2 is turned on. When the reset signal arrives at the control terminal 18 of the first transistor T1, the voltage at the control terminal 18 of the first transistor T1 becomes the reset voltage, and the first transistor T1 is also turned on. Since the SWEEP signal remains low for a preset time before turning high, the SWEEP signal is coupled through the eighth capacitor C8, so that after the voltage at the control terminal 17 of the second transistor T2 changes, the voltage remains unchanged.

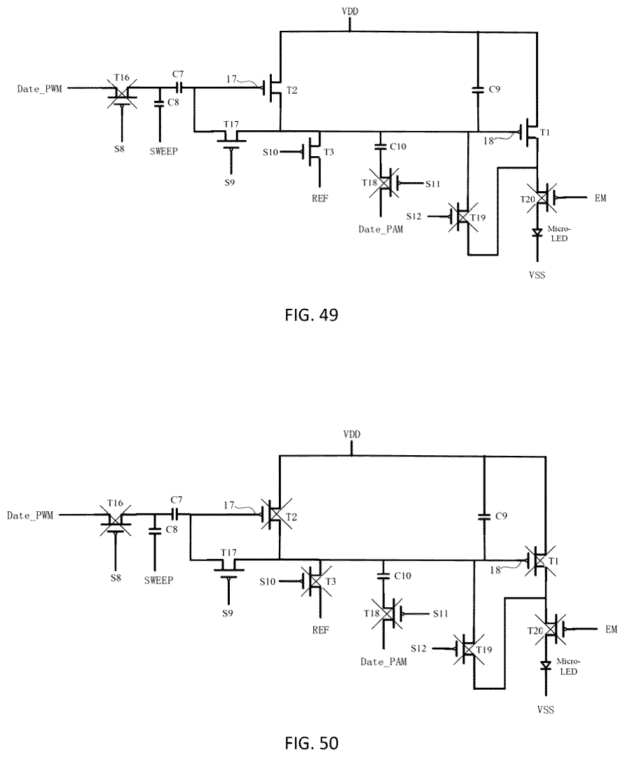

In the first compensation phase, corresponding to phase (2) in FIG. 48, the S9 signal and the Date_PWM signal are low-potential signals, while the S8 signal, the S10 signal, the S11 signal, the S12 signal, the EM signal, the Date_PAM signal, and the SWEEP signal are high-potential signals. Based on FIG. 47, FIG. 50 is a schematic diagram of the pixel circuit during the first compensation phase according to some embodiments of the present application. As shown in FIG. 50, transistors marked with “x” are in the turned-off state, which does not mean that the transistor does not exist, and unmarked transistors are in the turned-on state. Since S9 signal is low, transistor T17 is turned on; S8 signal, S10 signal, S11 signal, S12 signal, and EM signal are high, so the sixteenth transistor T16, the third transistor T3, the eighteenth transistor T18, the nineteenth transistor T19, and the twentieth transistor T20 are turned off. Because during the first reset phase, the second transistor T2 is turned on, and at the beginning of the first compensation phase, the reference power supply output terminal VDD applies voltage to the control terminal 17 of the second transistor T2 through the second transistor T2 and the seventeenth transistor T17. When the voltage at the control terminal 17 of the second transistor T2 reaches the first compensation voltage, the second transistor T2 is turned off. It should be noted that the first compensation voltage is the critical voltage at which the second transistor T2 is turned on and off. The first compensation voltage V_{A1}=V_{VDD}+Vₜₕ₁, where V_{VDD} represents the voltage output from the reference power supply output terminal VDD, Vₜₕ₁ represents the threshold voltage of the second transistor T2, and Vₜₕ₁ is a negative voltage. It should be noted that the second control signal output terminal SWEEP outputs a control signal with the second potential to ensure that the voltage at the control terminal 17 of the second transistor T2 remains unchanged after reaching the first compensation voltage.

At the beginning of the first compensation phase, the reference power supply output terminal VDD applies a voltage to the control terminal 18 of the first transistor T1 through the second transistor T2, and the voltage at the control terminal 18 of the first transistor T1 gradually increases. When the first compensation voltage is greater than or equal to the second compensation voltage, the second transistor T2 is turned off when the voltage at the control terminal 17 of the second transistor T2 reaches the first compensation voltage. At this time, the voltage at the control terminal 18 of the first transistor T1 also reaches the first compensation voltage, and the first transistor T1 is turned off. When the first compensation voltage is less than the second compensation voltage, the second transistor T2 is turned off when the voltage at the control terminal 17 of the second transistor T2 reaches the first compensation voltage. At this time, the voltage at the control terminal 18 of the first transistor T1 also reaches the first compensation voltage, and the voltage no longer increases, so the first transistor T1 is turned on.

Embodiments of the present application do not limit the state of the first transistor T1 during the first reset phase.

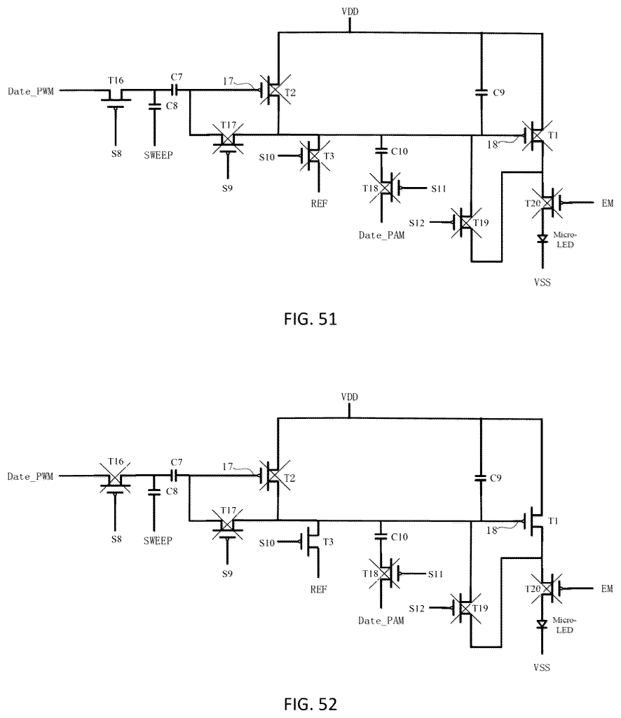

In the first data writing phase, corresponding to phase (3) in FIG. 48, S8 signal is a low-potential signal, and S9 signal, S10 signal, S11 signal, S12 signal, EM signal, Date_PAM signal, and SWEEP signal are high-potential signals. The Date_PWM signal remains low for a preset time before turning high. Based on FIG. 47, FIG. 51 is a schematic diagram of the pixel circuit during the fifth driving voltage writing phase according to some embodiments of the present application. As shown in FIG. 51, transistors marked with “x” are in the turned-off state, which does not mean that the transistor does not exist, and unmarked transistors are in the turned-on state. Since S8 signal is low, the sixteenth transistor T16 is turned on; S9 signal, S10 signal, S11 signal, S12 signal, and EM signal are high, so the seventeenth transistor T17, the third transistor T3, the eighteenth transistor T18, the nineteenth transistor T19, the twentieth transistor T20 are turned off. The PWM driving signal output terminal Date_PWM applies voltage to the control terminal 17 of the second transistor T2 through the sixteenth transistor T16 and the seventh capacitor C7 to the first driving voltage. The Date_PWM signal remains low for a preset duration before switching to high, ensuring that after the second transistor T2 is turned off, the voltage of this control signal is coupled through the seventh capacitor C7 to the control terminal 17 of the second transistor T2, making the voltage at the control terminal 17 the first driving voltage. Since the first driving voltage is greater than the first compensation voltage, the second transistor T2 remains off. It should be noted that the first driving voltage V_{A2}=V_{VDD}+Vₜₕ₁+V_{Date_PWM}, where V_{VDD} represents the voltage output from the reference power supply output terminal VDD, Vₜₕ₁ represents the threshold voltage of the second transistor T2, Vₜₕ₁ is a negative voltage, V_{Date_PWM} represents the voltage of the Date_PWM signal, and V_{Date_PWM} is a positive voltage. It should be noted that the second control signal output terminal SWEEP outputs a control signal with the second potential to ensure that the voltage at the control terminal 17 of the second transistor T2 remains unchanged after reaching the first driving voltage.

In the second reset phase, corresponding to phase (4) in FIG. 48, the S10 signal and the Date_PWM signal are low-potential signals, while the S8 signal, the S9 signal, the S11 signal, the S12 signal, the EM signal, the Date_PAM signal, and the SWEEP signal are high-potential signals. Based on FIG. 47, FIG. 52 is a schematic diagram of the pixel circuit in the second reset phase according to some embodiments of the present application. As shown in FIG. 52, transistors marked with “x” are in the turned-off state, which does not mean that the transistor does not exist, and unmarked transistors are in the turned-on state. Since S10 signal is low, the third transistor T3 is turned on; S8 signal, S9 signal, S11 signal, S12 signal, and EM signal are high, so the sixteenth transistor T16, the seventeenth transistor T17, the eighteenth transistor T18, the nineteenth transistor T19, the twentieth transistor T20 are turned off. The reset signal output terminal REF outputs a reset signal with a reset voltage. The reset signal passes through the third transistor T3 to the control terminal 18 of the first transistor T1, the first electrode of the ninth capacitor C9, and the second electrode of the tenth capacitor C10, so that the voltage at the control terminal 18 of the first transistor T1 is the reset voltage, and the ninth capacitor C9 and the tenth capacitor C10 are charged. Since the reset voltage is negative voltage, the first transistor T1 is turned on. Since the second control signal output terminal SWEEP outputs a control signal with the second potential, it ensures that the voltage at the control terminal 17 of the second transistor T2 remains unchanged after reaching the first driving voltage.

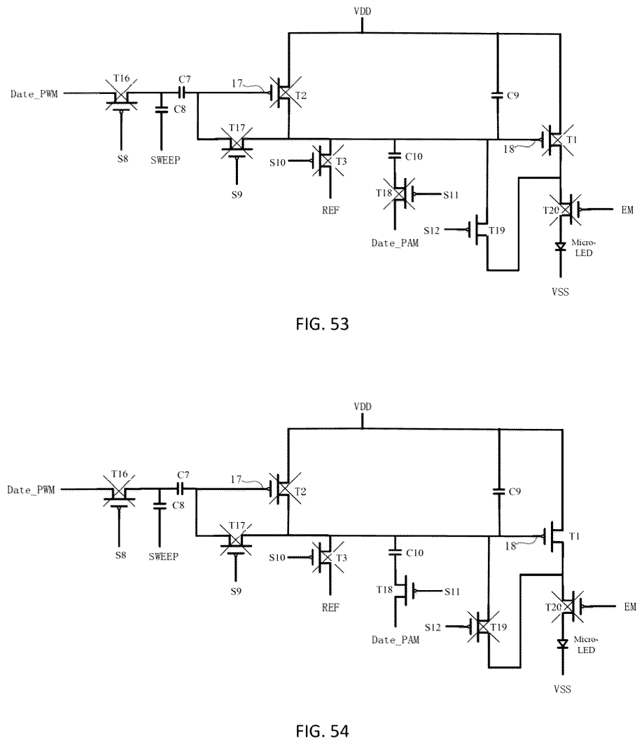

In the second compensation phase, corresponding to phase (5-1) in FIG. 48, the S12 signal and the Date_PWM signal are low-potential signals, while the S8 signal, S9 signal, S10 signal, S11 signal, EM signal, Date_PAM signal, and SWEEP signal are high-potential signals. Based on FIG. 47, FIG. 53 is a schematic diagram of the pixel circuit in the second compensation phase according to some embodiments of the present application. As shown in FIG. 53, transistors marked with “x” are in the turned-off state, which does not mean that the transistor does not exist, and unmarked transistors are in the turned-on state. Since S12 signal is low, the nineteenth transistor T19 is turned on; S8 signal, S9 signal, S10 signal, S11 signal, and EM signal are high, so the sixteenth transistor T16, the seventeenth transistor T17, the third transistor T3, the eighteenth transistor T18, the twentieth transistor T20 are turned off. Since during the second reset phase, the first transistor T1 is turned on, and at the beginning of the second compensation phase, the reference power supply output terminal VDD applies a voltage to the control terminal 18 of the first transistor T1 through the first transistor T1 and the nineteenth transistor T19. When the voltage at the control terminal 18 of the first transistor T1 reaches the second compensation voltage, the first transistor T1 is turned off. It should be noted that the second compensation voltage is the critical voltage at which the first transistor T1 is turned on and off. The second compensation voltage V_{B1}=V_{VDD}+Vₜₕ₂, where V_{VDD} represents the voltage output from the reference power supply output terminal VDD, Vₜₕ₂ represents the threshold voltage of the first transistor T1, and Vₜₕ₂ is a negative voltage. It should be noted that the second control signal output terminal SWEEP outputs a control signal with the second potential to ensure that the voltage at the control terminal 17 of the second transistor T2 remains unchanged after reaching the first compensation voltage.

In the second data writing phase, corresponding to phase (5-2) in FIG. 48, the S11 signal and the Date_PWM signal are low-potential signals, while the S8 signal, S9 signal, S10 signal, S12 signal, EM signal, and SWEEP signal are high-potential signals. The Date_PAM signal remains high for a preset duration before turning low. Based on FIG. 47, FIG. 54 is a schematic diagram of the pixel circuit during the sixth driving voltage writing phase according to some embodiments of the present application. As shown in FIG. 54, transistors marked with “x” are in the turned-off state, which does not mean that the transistor does not exist, and unmarked transistors are in the turned-on state. Since the S11 signal is a low-potential signal, the eighteenth transistor T18 is turned on; the S8 signal, S9 signal, S10 signal, S12 signal, and EM signal are high-potential signals, so the sixteenth transistor T16, the seventeenth transistor T17, the third transistor T3, the nineteenth transistor T19, and the twentieth transistor T20 are turned off. The PAM driving signal output terminal Date_PAM applies voltage to the control terminal 18 of the first transistor T1 through the eighteenth transistor T18 and the tenth capacitor C10 to the second driving voltage. The Date_PAM signal remains high for a preset duration before turning low, ensuring that after the first transistor T1 is turned off, the voltage of the control signal reaches the control terminal 18 of the first transistor T1 after being coupled through the tenth capacitor C10, so that the voltage at the control terminal 18 is the second driving voltage. Since the second driving voltage is less than the second compensation voltage, the first transistor T1 is turned on. It should be noted that, the second driving voltage

$${V}_{B 2} = {V}_{V D D} + {V}_{th 2} + \frac{{V}_{D ate\_PAM} \times {C}^{′} 4}{{C}^{′} 3 + {C}^{′} 4} ,$$

V_{VDD} represents the voltage output from the reference power supply output terminal VDD, Vₜₕ₂ represents the threshold voltage of the first transistor T1, and Vₜₕ₂ is a negative voltage; V_{Date_PAM} represents the voltage of the Date_PAM signal, and V_{Date_PAM} is a negative voltage; C′3 represents the capacitance value of capacitor C9, and C′4 represents the capacitance value of capacitor C10. It should be noted that the second control signal output terminal SWEEP outputs a control signal with the second potential to ensure that the voltage at the control terminal 17 of the second transistor T2 remains unchanged after reaching the first driving voltage.

In the light-emitting phase, corresponding to phase (6) in FIG. 48, the EM signal and Date_PWM signal are low-potential signals, while the S8 signal, S9 signal, S10 signal, S11 signal, S12 signal, and Date_PAM signal are high-potential signals. The potential of the SWEEP signal gradually changes from high potential to low potential.

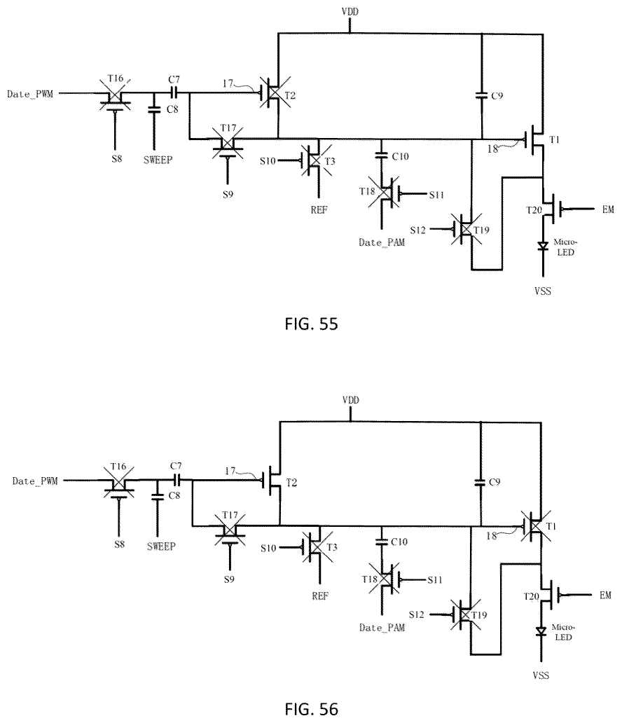

Based on FIG. 47, FIG. 55 is a schematic diagram of a pixel circuit during the light-emitting phase according to some embodiments of the present application. As shown in FIG. 55, transistors marked with “x” are in the turned-off state, which does not mean that the transistor does not exist, and unmarked transistors are in the turned-on state. Since the EM signal is a low-potential signal, the twentieth transistor T20 is turned on; the S8 signal, S9 signal, S10 signal, S11 signal, and S12 signal are high-potential signals, so the sixteenth transistor T16, the seventeenth transistor T17, the third transistor T3, the eighteenth transistor T18, and the nineteenth transistor T19 are turned off. The current output from the reference power supply VDD passes sequentially through the first transistor T1 and the twentieth transistor T20 to reach the light-emitting element, such as the micro-LED, driving the micro-LED to emit light.

Based on FIG. 47, FIG. 56 is another schematic diagram of a pixel circuit during the light-emitting phase according to some embodiments of the present application. As shown in FIG. 56, transistors marked with “x” are in the turned-off state, which does not mean that the transistor does not exist, and unmarked transistors are in the turned-on state. As the SWEEP signal potential gradually changes from high to low, the voltage at the control terminal 17 of the second transistor T2 gradually changes to the first driving voltage, and the second transistor T2 is turned on. The reference power supply output terminal VDD applies a voltage to the control terminal 18 of the first transistor T1 through the second transistor T2 to the second compensation voltage, and charges the ninth capacitor C9 and the tenth capacitor C10. When the voltage at the control terminal 18 of the first transistor T1 is the second compensation voltage, the first transistor T1 is turned off, and the micro-LED stops emitting light.

In this way, by connecting the first electrode of the seventeenth transistor to the gate electrode of the second transistor and connecting the second electrode to the second electrode of the second transistor, in the first compensation phase, the voltage of the gate electrode (i.e., the control terminal) of the second transistor is made to reach the first compensation voltage through the seventeenth transistor, thus completing the threshold voltage compensation. By connecting the first electrode of the nineteenth transistor to the gate electrode (i.e., the control terminal) of the first transistor and the second electrode to the second electrode of the first transistor, in the second compensation phase, the voltage of the gate electrode (i.e., the control terminal) of the first transistor is made to reach the second compensation voltage through the nineteenth transistor, thus completing the threshold voltage compensation. By using the seventeenth transistor to perform threshold voltage compensation on the PWM driving circuit and the nineteenth transistor to perform threshold voltage compensation on the PAM driving circuit, it can be ensured that the TFTs in the PWM driving circuit and PAM driving circuit will not experience threshold voltage drift. This makes the current flowing through the light-emitting elements such as micro LEDs more stable, and the light emission duration and wavelength of the micro LEDs will not change, thus improving the display effect.

In the above embodiments, the switching circuits are all P-type TFTs. In some cases, at least one of the switching circuits included in the pixel circuit can be an N-type TFT. The following explanation addresses the case where the switching circuit included in the pixel circuit is N-type TFTs.

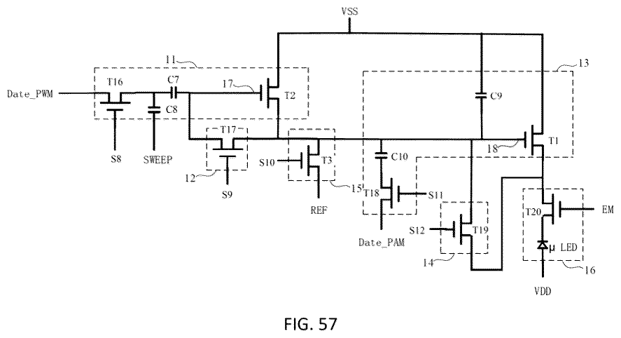

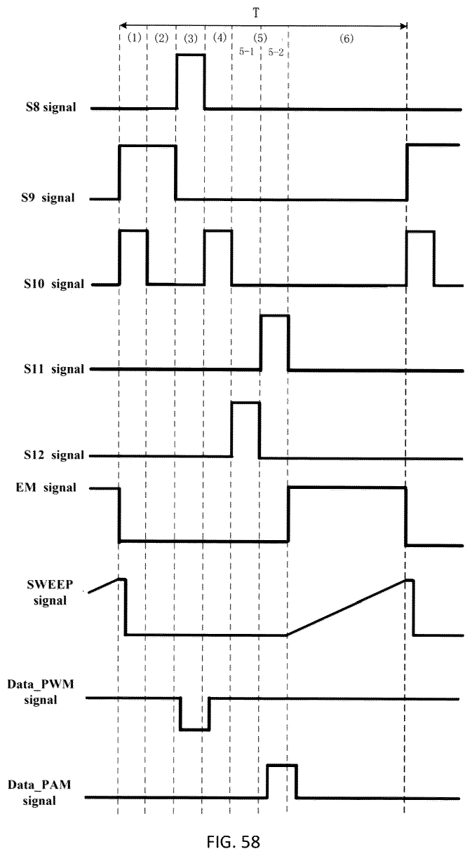

Based on FIG. 47, FIG. 57 is another schematic diagram of the structure of a pixel circuit according to some embodiments of the present application. As shown in FIG. 57, the switching circuits in the figure are N-type TFTs. In FIG. 57, the first power supply terminal is the ground electrode VSS, and the second power supply terminal is the reference power supply output terminal VDD; the light-emitting element is a micro-LED, with the first electrode of the light-emitting element being the negative electrode and the second electrode of the light-emitting element being the positive electrode; the first potential is high potential and the second potential is low potential. FIG. 58 is a timing diagram of control signals according to some embodiments of the present application, which is configured to control the pixel circuit shown in FIG. 57.

In the first reset phase, corresponding to phase (1) in FIG. 58, S9 signal, S10 signal, and Date_PWM signal are high-potential signals, while S8 signal, S11 signal, S12 signal, EM signal, and Date_PAM signal are low-potential signals. The SWEEP signal remains high for a preset duration before turning low.

In the first compensation phase, corresponding to phase (2) in FIG. 58, the S9 signal and the Date_PWM signal are high-potential signals, while the S8 signal, the S10 signal, the S11 signal, the S12 signal, the EM signal, the Date_PAM signal, and the SWEEP signal are low-potential signals. The reference power supply output terminal VDD applies voltage to the control terminal 17 of the second transistor T2 through the second transistor T2 and the seventeenth transistor T17, so that the voltage at the control terminal 17 of the second transistor T2 reaches the first compensation voltage.

In the first data writing phase, corresponding to phase (3) in FIG. 58, S8 signal is a high-potential signal, and S9 signal, S10 signal, S11 signal, S12 signal, EM signal, Date_PAM signal, and SWEEP signal are low-potential signals. The Date_PWM signal remains high for a preset time before turning low.

In the second reset phase, corresponding to phase (4) in FIG. 58, the S10 signal and the Date_PWM signal are high-potential signals, while the S8 signal, the S9 signal, the S11 signal, the S12 signal, the EM signal, the Date_PAM signal, and the SWEEP signal are low-potential signals.

In the second compensation phase, corresponding to phase (5-1) in FIG. 58, the S12 signal and the Date_PWM signal are high-potential signals, while the S8 signal, S9 signal, S10 signal, S11 signal, EM signal, Date_PAM signal, and SWEEP signal are low-potential signals. The reference power supply output terminal VDD applies voltage to the control terminal 18 of the first transistor T1 through the first transistor T1 and the nineteenth transistor T19, so that the voltage at the control terminal 18 of the first transistor T1 reaches the second compensation voltage.

In the second data writing phase, corresponding to phase (5-2) in FIG. 58, the S11 signal and the Date_PWM signal are high-potential signals, while the S8 signal, S9 signal, S10 signal, S12 signal, EM signal, and SWEEP signal are low-potential signals. The Date_PAM signal remains low for a preset duration before turning high.

In the light-emitting phase, corresponding to phase (6) in FIG. 58, the EM signal and Date_PWM signal are high-potential signals, while the S8 signal, S9 signal, S10 signal, S11 signal, S12 signal, and Date_PAM signal are low-potential signals. The potential of the SWEEP signal gradually changes from low to high.

It should be noted that the implementation process and technical effects at each phase are described in the above embodiments and will not be repeated here.

Based on the same inventive concept, a display apparatus as shown in FIG. 1 according to some embodiments of the present application can include a data driving circuit 500, a scan driving circuit 700, a plurality of data lines DL, a plurality of scan lines SL, and a pixel array unit 100, where the pixel array unit 100 can include the corresponding pixel circuit in any of the foregoing embodiments.

For ease of explanation, the above description has been provided in conjunction with embodiments. However, the above discussion in embodiments is not intended to be exhaustive or to limit the implementation to the specific forms disclosed above. Based on the teachings herein, various modifications and variations can be made. The above-described embodiments are chosen to better explain the principles and practical applications, thereby enabling those skilled in the art to better use the embodiments and various modified embodiments suitable for specific applications.

What is claimed is:

1. A pixel circuit, comprising a first transistor, a second transistor, a third transistor, and a light-emitting element, wherein:
a first electrode of the first transistor and a first electrode of the second transistor are configured to receive a power signal, a second electrode of the first transistor is connected to the light-emitting element, and a gate electrode of the first transistor is connected to a second electrode of the second transistor, a gate electrode of the second transistor and a second electrode of the third transistor;
a first electrode of the third transistor is configured to receive a reset signal, and a gate electrode of the third transistor is configured to receive a reset control signal;
the first transistor is configured to provide a driving signal to the light-emitting element, the second transistor is configured to provide a light emission duration control signal to the first transistor to control a light emission duration of the light-emitting element, and the third transistor is configured to provide the reset signal to the gate electrode of the second transistor and the gate electrode of the first transistor in response to the reset control signal received at the gate electrode of the third transistor.

2. The pixel circuit according to claim 1, further comprising a first capacitor;
wherein a first electrode of the first capacitor is connected to the gate electrode of the first transistor, and a second electrode of the first capacitor is configured to receive the power signal.

3. The pixel circuit according to claim 1, further comprising a fourth transistor; wherein:
a first electrode of the fourth transistor is connected to the gate electrode of the first transistor, a second electrode of the fourth transistor is connected to the second electrode of the first transistor, and a gate electrode of the fourth transistor is configured to receive a first compensation control signal;
the fourth transistor is configured to provide threshold compensation for the first transistor in response to the first compensation control signal received at the gate electrode of the fourth transistor.

4. The pixel circuit according to claim 1, further comprising a fifth transistor; wherein:
a first electrode of the fifth transistor is connected to the gate electrode of the second transistor, a second electrode of the fifth transistor is connected to the second electrode of the second transistor and the second electrode of the third transistor, and a gate electrode of the fifth transistor is configured to receive a first compensation and reset control signal;
the fifth transistor is configured to, in response to the first compensation and reset control signal received at the gate electrode of the fifth transistor, provide the reset signal provided by the third transistor and received at the second electrode of the fifth transistor to the gate electrode of the second transistor through the first electrode of the fifth transistor; or
the fifth transistor is configured to, in response to the first compensation and reset control signal received at the gate electrode of the fifth transistor, provide threshold compensation for the second transistor.

5. The pixel circuit according to claim 1, further comprising: a sixth transistor; wherein:
a first electrode of the sixth transistor is configured to receive a first data signal, a second electrode of the sixth transistor is connected to the first electrode of the first transistor, a gate electrode of the sixth transistor is configured to receive a first data writing control signal;
the sixth transistor is configured to write the first data signal into the first electrode of the first transistor in response to the first data writing control signal received at the gate electrode of the sixth transistor.

6. The pixel circuit according to claim 1, further comprising a seventh transistor; wherein:
a first electrode of the seventh transistor is configured to receive a second data signal, a second electrode of the seventh transistor is connected to the gate electrode of the second transistor, and a gate electrode of the seventh transistor is configured to receive a second data writing control signal;
the seventh transistor is configured to write the second data signal into the gate electrode of the second transistor in response to the second data writing control signal received at the gate electrode of the seventh transistor.

7. The pixel circuit according to claim 6, further comprising a second capacitor; wherein:
a first electrode of the second capacitor is connected to the second electrode of the seventh transistor, and a second electrode of the second capacitor is connected to the gate electrode of the second transistor;
the second capacitor is configured to couple the second data signal written by the seventh transistor to the gate electrode of the second transistor.

8. The pixel circuit according to claim 7, further comprising a third capacitor; wherein:
a first electrode of the third capacitor is connected to the first electrode of the second capacitor, and a second electrode of the third capacitor is configured to receive the light emission duration control signal;
the third capacitor is configured to couple the light emission duration control signal received at the second electrode of the third capacitor to the gate electrode of the second transistor through the second capacitor.

9. The pixel circuit according to claim 1, further comprising an eighth transistor; wherein:
a first electrode of the eighth transistor is configured to receive the power signal, a second electrode of the eighth transistor is connected to the first electrode of the first transistor, and a gate electrode of the eighth transistor is configured to receive a first driving control signal;
the eighth transistor is configured to, in response to the first driving control signal received at the gate electrode of the eighth transistor, provide the power signal received at the first electrode of the eighth transistor to the first electrode of the first transistor through the second electrode of the eighth transistor.

10. The pixel circuit according to claim 1, further comprising a ninth transistor; wherein:
a first electrode of the ninth transistor is connected to the first electrode of the first transistor, a second electrode of the ninth transistor is connected to the light-emitting element, and a gate electrode of the ninth transistor is configured to receive a second driving control signal;
the ninth transistor is configured to, in response to the second driving control signal received at the gate electrode of the ninth transistor, provide the driving signal provided by the first transistor and received at the first electrode of the ninth transistor to the light-emitting element through the second electrode of the ninth transistor.

11. The pixel circuit according to claim 1, further comprising a tenth transistor; wherein:
a first electrode of the tenth transistor is configured to receive a third data signal, a second electrode of the tenth transistor is connected to the gate electrode of the first transistor, and a gate electrode of the tenth transistor is configured to receive a third data writing control signal;
the tenth transistor is configured to provide the third data signal into the gate electrode of the first transistor in response to the third data writing control signal received at the gate electrode of the tenth transistor.

12. The pixel circuit according to claim 11, further comprising an eleventh transistor; wherein:
a first electrode of the eleventh transistor is connected to the gate electrode of the second transistor, a second electrode of the eleventh transistor is connected to the second electrode of the second transistor and the second electrode of the third transistor, and a gate electrode of the eleventh transistor is configured to receive a second compensation and reset control signal;
the eleventh transistor is configured to provide the reset signal provided by the third transistor to the gate electrode of the second transistor in response to the second compensation and reset control signal received at the gate electrode of the eleventh transistor; and
the eleventh transistor is further configured to provide threshold compensation for the second transistor in response to the second compensation and reset control signal received at the gate electrode of the eleventh transistor.

13. The pixel circuit according to claim 12, further comprising a twelfth transistor; wherein:
a first electrode of the twelfth transistor is connected to the first electrode of the second transistor, a second electrode of the twelfth transistor is configured to receive a fourth data signal, and a gate electrode of the twelfth transistor is configured to receive a fourth data writing control signal;
the twelfth transistor is configured to write the fourth data signal into the first electrode of the second transistor in response to the fourth data writing control signal received at the gate electrode of the twelfth transistor; the second transistor is further configured to transmit the fourth data signal received at the first electrode of the second transistor to the second electrode of the second transistor after being turned on;
the eleventh transistor is further configured to provide the fourth data signal to the gate electrode of the second transistor in response to the second compensation and reset control signal received at the gate electrode of the eleventh transistor, and provide threshold compensation for the second transistor.

14. The pixel circuit according to claim 13, further comprising a fourteenth transistor; wherein:
a first electrode of the fourteenth transistor is configured to receive the power signal, a second electrode of the fourteenth transistor is connected to the first electrode of the second transistor and the first electrode of the twelfth transistor, and a gate electrode of the fourteenth transistor is configured to receive a third driving control signal;
the fourteenth transistor is configured to, in response to the third driving control signal received at the gate electrode of the fourteenth transistor, provide the power signal received at the first electrode of the fourteenth transistor to the first electrode of the second transistor through the second electrode of the fourteenth transistor.

15. The pixel circuit according to claim 11, further comprising a fourth capacitor; wherein:
a first electrode of the fourth capacitor is connected to the second electrode of the tenth transistor, and a second electrode of the fourth capacitor is connected to the gate electrode of the first transistor;
the fourth capacitor is configured to couple the third data signal written by the tenth transistor to the gate electrode of the first transistor.

16. A method for driving the pixel circuit according to claim 1, comprising:
in a first reset phase, controlling the third transistor to turn on in response to the reset control signal being at an active potential; providing the reset signal to the gate electrode of the first transistor and the gate electrode of the second transistor through the third transistor; and controlling the second transistor to turn on in response to the reset signal.

17. The method according to claim 16, wherein the pixel circuit further comprises: a fourth transistor, a fifth transistor, a sixth transistor, a seventh transistor, an eighth transistor, a ninth transistor, a first capacitor, a second capacitor, and a third capacitor; wherein:
a first electrode of the fourth transistor is connected to the gate electrode of the first transistor, a second electrode of the fourth transistor is connected to the second electrode of the first transistor, and a gate electrode of the fourth transistor is configured to receive a first compensation control signal;
a first electrode of the fifth transistor is connected to the gate electrode of the second transistor, a second electrode of the fifth transistor is connected to the second electrode of the second transistor and the second electrode of the third transistor, and a gate electrode of the fifth transistor is configured to receive a first compensation and reset control signal;
a first electrode of the sixth transistor is configured to receive a first data signal, a second electrode of the sixth transistor is connected to the first electrode of the first transistor, a gate electrode of the sixth transistor is configured to receive a first data writing control signal;
a first electrode of the seventh transistor is configured to receive a second data signal, a second electrode of the seventh transistor is connected to the gate electrode of the second transistor, and a gate electrode of the seventh transistor is configured to receive a second data writing control signal;
a first electrode of the eighth transistor is configured to receive the power signal, a second electrode of the eighth transistor is connected to the first electrode of the first transistor, and a gate electrode of the eighth transistor is configured to receive a first driving control signal;
a first electrode of the ninth transistor is connected to the first electrode of the first transistor, a second electrode of the ninth transistor is connected to the light-emitting element, and a gate electrode of the ninth transistor is configured to receive a second driving control signal;
a first electrode of the first capacitor is connected to the gate electrode of the first transistor, and a second electrode of the first capacitor is configured to receive the power signal;
a first electrode of the second capacitor is connected to the second electrode of the seventh transistor, and a second electrode of the second capacitor is connected to the gate electrode of the second transistor; and
a first electrode of the third capacitor is connected to the first electrode of the second capacitor, and a second electrode of the third capacitor is configured to receive the light emission duration control signal;
wherein the method further comprises: a first compensation phase, a first data writing phase, a second reset phase, a second compensation phase, a second data writing phase, and a light-emitting phase sequentially arranged after the first reset phase;
in the first reset phase, controlling the fifth transistor to turn on in response to the first compensation and reset control signal being at the active potential; providing the reset signal to the gate electrode of the second transistor further through the fifth transistor; charging the second capacitor in response to the reset signal provided to the gate electrode of the second transistor; and resetting a potential at the gate electrode of the second transistor to a potential of the reset signal in response to the reset signal provided to the gate electrode of the second transistor;
in the first compensation phase, controlling the fifth transistor and the second transistor to turn on in response to the first compensation and reset control signal being at the active potential;
providing the power signal to the second electrode of the second transistor through the second transistor; and performing a compensation for a threshold voltage of the second transistor using the potential at the gate electrode of the second transistor through the fifth transistor;
in the first data writing phase, controlling the seventh transistor to turn on in response to the second data writing control signal being at the active potential; providing the second data signal being at the active potential to the first electrode of the second capacitor through the seventh transistor; and coupling the second data signal to the gate electrode of the second transistor through the second capacitor;
in the second reset phase, controlling the third transistor to turn on in response to the reset control signal being at the active potential; charging the first capacitor using the reset signal passing through the third transistor; resetting a potential at the gate electrode of the first transistor to the potential of the reset signal; and controlling the first transistor to turn on;
in the second compensation phase and the second data writing phase, controlling the fourth transistor to turn on in response to the first compensation control signal being at the active potential; controlling the sixth transistor to turn on in response to the first data writing control signal being at the active potential; writing the first data signal to the first electrode of the first transistor through the sixth transistor; and performing a compensation for a threshold voltage of the first transistor using the first data signal through the first transistor and the fourth transistor;
in the light-emitting phase, controlling the eighth transistor to turn on in response to the first driving control signal being at the active potential; controlling the ninth transistor to turn on in response to the second driving control signal being at the active potential; driving the light-emitting element to emit light using the power signal passing through the eighth transistor, the first transistor and the ninth transistor; controlling the potential at the gate electrode of the second transistor gradually transition to the active potential until the second transistor is turned on, as the light emission duration control signal gradually changes from an inactive potential to the active potential, combined with a coupling effect of the second capacitor and the third capacitor; charging the first capacitor using the power signal passing through the second transistor in response to the second transistor being turned on; controlling the potential at the gate electrode of the first transistor gradually transition to the inactive potential until the first transistor is turned off and the light emitting element stops emitting light.

18. The method according to claim 17, wherein, in the first data writing phase, an ending time of the active potential of the second data signal lags behind an ending time of the active potential of the second data writing control signal by a first preset time.

19. The method according to claim 16, wherein the pixel circuit further comprises: a tenth transistor and a fourth capacitor;
a first electrode of the tenth transistor is configured to receive a third data signal, a second electrode of the tenth transistor is connected to the gate electrode of the first transistor, and a gate electrode of the tenth transistor is configured to receive a third data writing control signal; and
a first electrode of the fourth capacitor is connected to the second electrode of the tenth transistor, and a second electrode of the fourth capacitor is connected to the gate electrode of the first transistor,
wherein an ending time of the active potential of the third data signal lags behind an ending time of the active potential of the third data writing control signal by a second preset time when writing the third data signal into the tenth transistor.

20. A display apparatus, comprising: a data driving circuit, a scan driving circuit, a plurality of data lines, a plurality of scan lines, and the pixel circuit according to claim 1.
